(19) United States
(12) Patent Application Publication
(10) Pub. No.: US 2025/0227659 A1
(43) Pub. Date: Jul. 10, 2025

(54) FREQUENCY DIFFERENCE OF ARRIVAL-BASED POSITIONING

(71) Applicant: QUALCOMM Incorporated, San Diego, CA (US)

(72) Inventors: Chiranjib SAHA, Lakeside, CA (US); Harikumar KRISHNAMURTHY, San Diego, CA (US); Alberto RICO ALVARINO, San Diego, CA (US); Alexandros MANOLAKOS, Athens (GR); Changhwan PARK, San Diego, CA (US)

(21) Appl. No.: 18/855,414

(22) PCT Filed: Mar. 29, 2023
(86) PCT No.: PCT/US2023/016669

§ 371 Date: Oct. 9, 2024

(30) Foreign Application Priority Data
May 30, 2022 (GR) 20220100452

(51) Int. Cl. H04W 64/00; G01S 5/00; G01S 5/02; G01S 5/10

(52) U.S. Cl. CPC H04W 64/006; G01S 5/0036; G01S 5/0236; G01S 5/0246; G01S 5/10

(57) ABSTRACT

Disclosed are techniques for wireless positioning. In an aspect, a user equipment (UE) receives, from a location server, assistance data for a positioning procedure, obtains a frequency offset measurement of one or more positioning reference signal (PRS) resources transmitted by at least one transmission-reception point (TRP) based on the assistance data, and enables a location of the UE to be determined based, at least in part, on the frequency offset measurement.

### CROSS-REFERENCE TO RELATED APPLICATIONS

The present application for patent claims priority to Greek patent application No. 20220100452, entitled “FREQUENCY DIFFERENCE OF ARRIVAL-BASED POSITIONING,” filed May 30, 2022, and is a national stage application, filed under 35 U.S.C. § 371, of International Patent Application No. PCT/US2023/016669, entitled “FREQUENCY DIFFERENCE OF ARRIVAL-BASED POSITIONING,” filed Mar. 29, 2023, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) includes receiving, from a location server, assistance data for a positioning procedure; obtaining a frequency offset measurement of one or more positioning reference signal (PRS) resources transmitted by at least one transmission-reception point (TRP) based on the assistance data; and enabling a location of the UE to be determined based, at least in part, on the frequency offset measurement.

In an aspect, a method of positioning performed by a network entity includes transmitting, to a user equipment (UE), assistance data for a positioning procedure; receiving, from the UE, a frequency offset measurement of one or more positioning reference signal (PRS) resources transmitted by at least one transmission-reception point (TRP); and determining a location of the UE based, at least in part, on the frequency offset measurement.

In an aspect, a user equipment (UE) includes a memory; at least one transceiver; and at least one processor communicatively coupled to the memory and the at least one transceiver, the at least one processor configured to: receive, via the at least one transceiver, assistance data for a positioning procedure; obtain a frequency offset measurement of one or more positioning reference signal (PRS) resources transmitted by at least one transmission-reception point (TRP) based on the assistance data; and enable a location of the UE to be determined based, at least in part, on the frequency offset measurement.

In an aspect, a network entity includes a memory; at least one transceiver; and at least one processor communicatively coupled to the memory and the at least one transceiver, the at least one processor configured to: transmit, via the at least one transceiver, to a user equipment (UE), assistance data for a positioning procedure; receive, via the at least one transceiver, from the UE, a frequency offset measurement of one or more positioning reference signal (PRS) resources transmitted by at least one transmission-reception point (TRP); and determine a location of the UE based, at least in part, on the frequency offset measurement.

In an aspect, a user equipment (UE) includes means for receiving assistance data for a positioning procedure; means for obtaining a frequency offset measurement of one or more positioning reference signal (PRS) resources transmitted by at least one transmission-reception point (TRP) based on the assistance data; and means for enabling a location of the UE to be determined based, at least in part, on the frequency offset measurement.

In an aspect, a network entity includes means for transmitting, to a user equipment (UE), assistance data for a positioning procedure; means for receiving, from the UE, a frequency offset measurement of one or more positioning reference signal (PRS) resources transmitted by at least one transmission-reception point (TRP); and means for determining a location of the UE based, at least in part, on the frequency offset measurement.

In an aspect, a non-transitory computer-readable medium stores computer-executable instructions that, when executed by a user equipment (UE), cause the UE to: receive assistance data for a positioning procedure; obtain a frequency offset measurement of one or more positioning reference signal (PRS) resources transmitted by at least one transmission-reception point (TRP) based on the assistance data; and enable a location of the UE to be determined based, at least in part, on the frequency offset measurement.

In an aspect, a non-transitory computer-readable medium stores computer-executable instructions that, when executed by a network entity, cause the network entity to: transmit, to a user equipment (UE), assistance data for a positioning procedure; receive, from the UE, a frequency offset measurement of one or more positioning reference signal (PRS) resources transmitted by at least one transmission-reception point (TRP); and determine a location of the UE based, at least in part, on the frequency offset measurement.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) call flow between a UE and a location server for performing positioning operations.

FIG. 6 is a diagram illustrating an example frame structure, according to aspects of the disclosure.

FIG. 7 is a graph representing a radio frequency (RF) channel impulse response over time, according to aspects of the disclosure.

FIG. 8 is a diagram illustrating an example system geometry for a frequency difference of arrival (FDOA) positioning procedure, according to aspects of the disclosure.

FIG. 9 is a diagram illustrating system geometry for Doppler shift computation for a non-geostationary satellite system, according to aspects of the disclosure.

FIG. 10 is a graph illustrating an example Doppler shift scenario with a two gigahertz (GHz) signal at 600 kilometers (km) on the downlink and uplink, according to aspects of the disclosure.

FIG. 11 is a graph illustrating an example Doppler shift scenario with a two GHz signal at 1500 km on the downlink and uplink, according to aspects of the disclosure.

FIG. 12 illustrates determining time domain correlation among narrowband reference signals, according to aspects of the disclosure.

FIG. 13 illustrates examples of intra-slot and inter-slot frequency offset measurements, according to aspects of the disclosure.

FIG. 14 illustrates examples of intra-slot and inter-slot comb pattern repetition, according to aspects of the disclosure.

FIGS. 15 and 16 illustrate example methods of positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

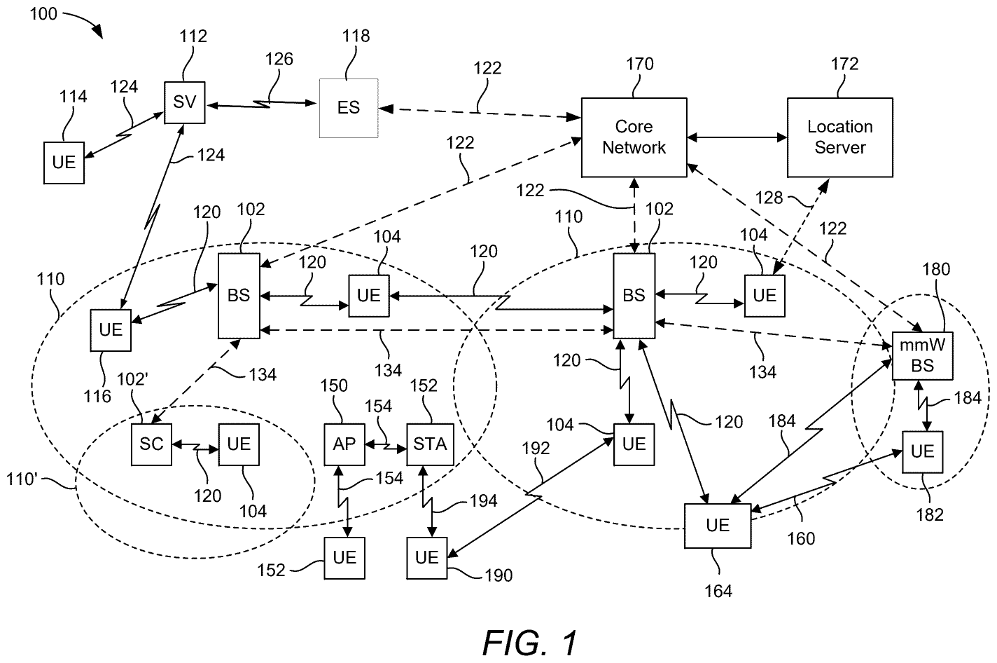

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as UEs 114 and 116 for simplicity) may receive signals 124 from one or more Earth orbiting space vehicles (SVs) 112 (e.g., satellites). In an aspect, the SVs 112 may be part of a satellite positioning system that the UEs 114 and/or 116 (or any other UE) can use as an independent source of location information. A satellite positioning system typically includes a system of transmitters (e.g., SVs 112) positioned to enable receivers (e.g., UEs 114 and/or 116) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE (e.g., UEs 114 and/or 116) may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (ES) 118 (also referred to as a ground station, NTN gateway, or gateway), which in turn is connected to an element in a 5G network, such as a modified base station 102 (without a terrestrial antenna) or a network node in a 5GC (e.g., core network 170). This element would in turn provide access to other elements in the 5G network and ultimately to entities external to the 5G network, such as Internet web servers and other user devices. In that way, a UE 114 and/or 116 may receive communication signals (e.g., signals 124) from an SV 112 instead of, or in addition to, communication signals from a terrestrial base station 102. The radio link between a UE (e.g., UE 114, 116) and an SV 112 is referred to as a “service link” (e.g., service links 124). The radio link between an SV 112 and the earth station 118 is referred to as a “feeder link” (e.g., feeder link 126).

NTNs may also be used to reinforce 5G service reliability by providing service continuity for machine-to-machine (M2M) and/or IoT devices, or for passengers on board moving platforms (e.g., passenger vehicles such as aircraft, ships, high speed trains, buses, etc.), or ensuring service availability anywhere, especially for critical communications. NTNs can also enable 5G network scalability by providing efficient multicast/broadcast resources for data delivery towards the network edges or even the UE (e.g., UEs 114 and/or 116).

In the example of FIG. 1, an SV 112 is in communication with a UE 114 outside the coverage area of a base station 102 (representing a UE in an area that is not served by a terrestrial 5G network) and with a UE 116 inside the coverage area of a base station 102 (representing a UE that is under-served by the terrestrial 5G network). Thus, SV 112 may act as a serving base station to UE 114 and as a primary cell or a secondary cell to UE 116, depending on the service provided to UE 116 by base station 102.

Note that although FIG. 1 only illustrates a single SV 112 and a single earth station 118, as will be appreciated, this is merely an example, and there may be any number of SVs 112 connected to any number of earth stations 118.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

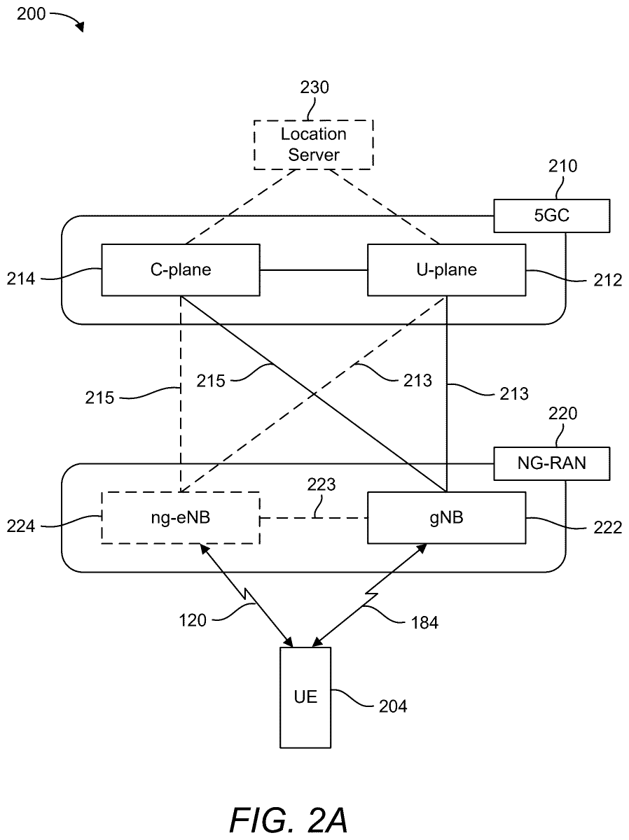

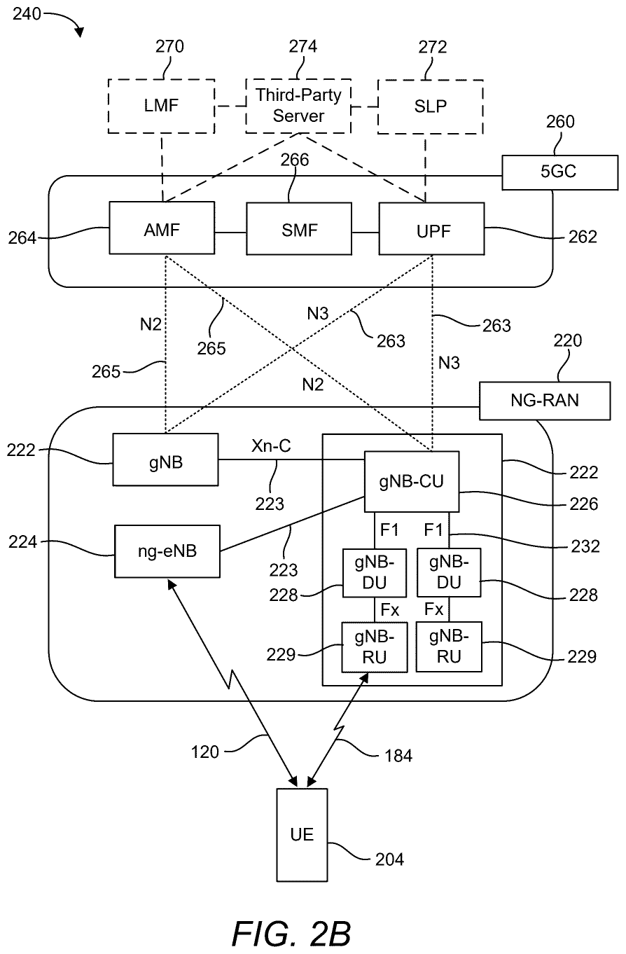

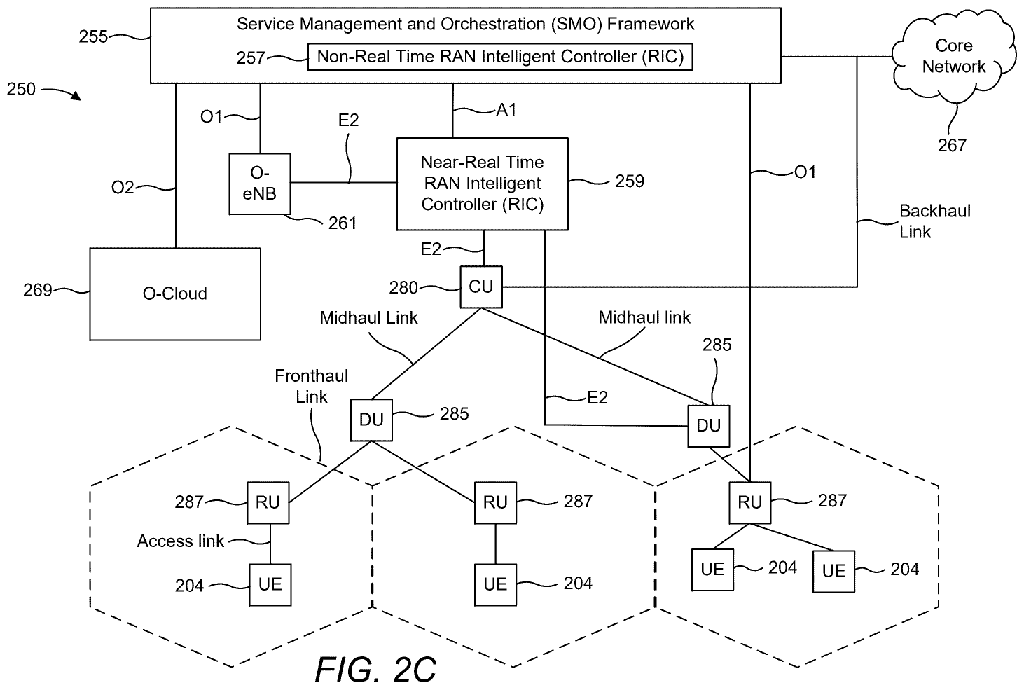

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

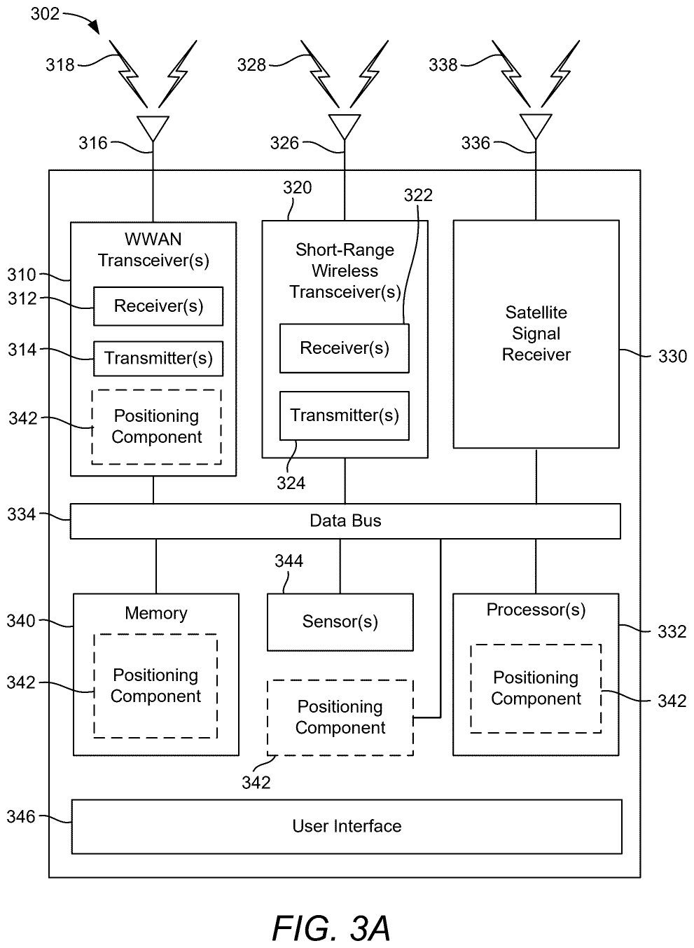

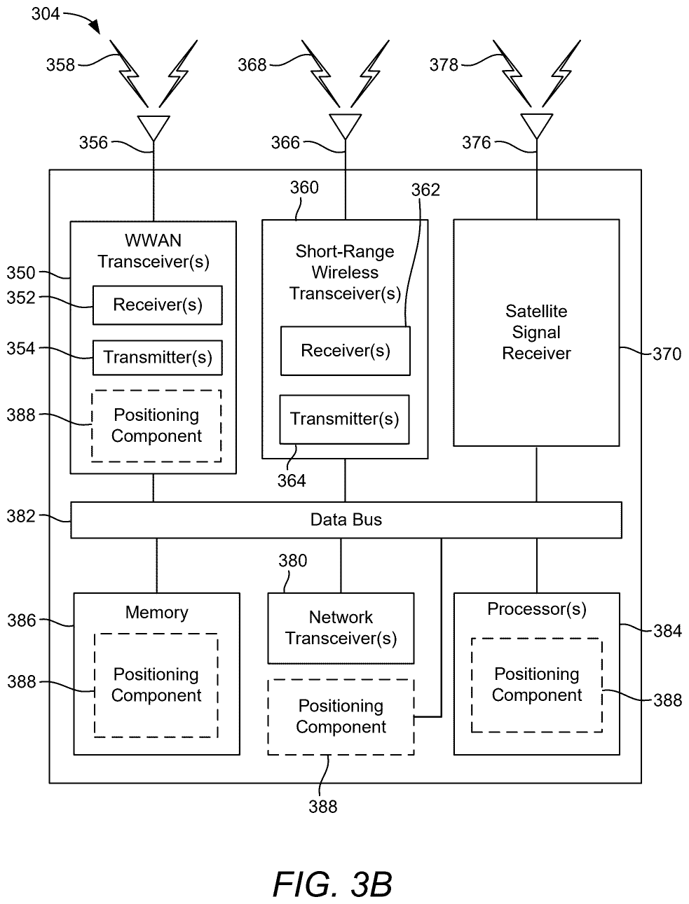

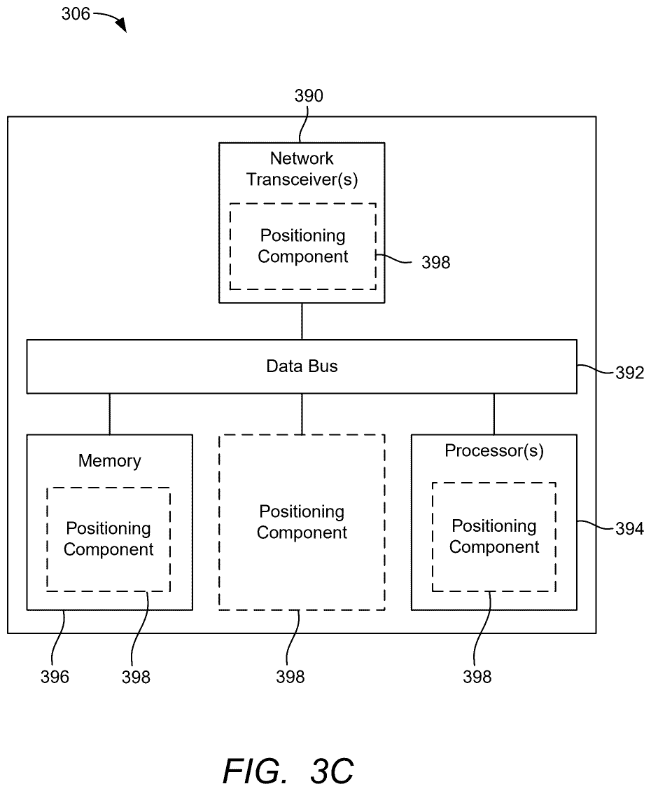

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and header measurement reporting; PDCP layer functionality associated with compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

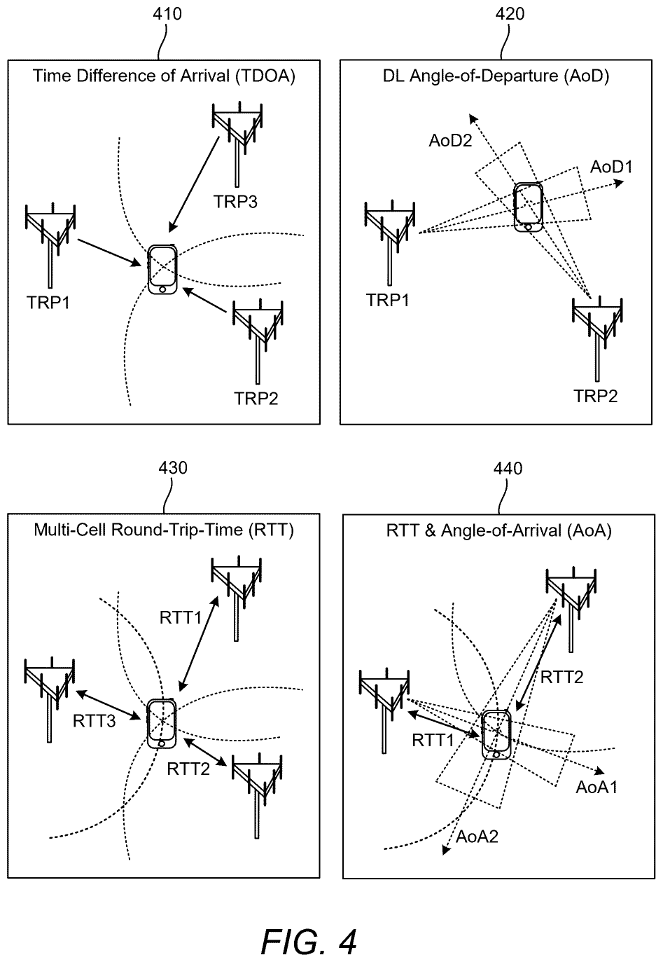

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

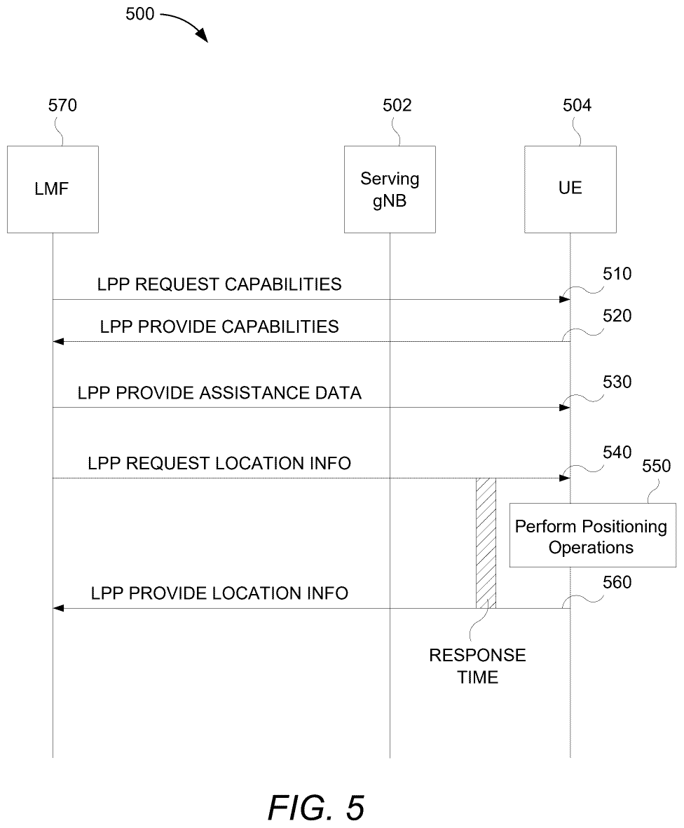

FIG. 5 illustrates an example Long-Term Evolution (LTE) positioning protocol (LPP) procedure 500 between a UE 504 and a location server (illustrated as a location management function (LMF) 570) for performing positioning operations. As illustrated in FIG. 5, positioning of the UE 504 is supported via an exchange of LPP messages between the UE 504 and the LMF 570. The LPP messages may be exchanged between UE 504 and the LMF 570 via the UE's 504 serving base station (illustrated as a serving gNB 502) and a core network (not shown). The LPP procedure 500 may be used to position the UE 504 in order to support various location-related services, such as navigation for UE 504 (or for the user of UE 504), or for routing, or for provision of an accurate location to a public safety answering point (PSAP) in association with an emergency call from UE 504 to a PSAP, or for some other reason. The LPP procedure 500 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 504 may receive a request for its positioning capabilities from the LMF 570 at stage 510 (e.g., an LPP Request Capabilities message). At stage 520, the UE 504 provides its positioning capabilities to the LMF 570 relative to the LPP protocol by sending an LPP Provide Capabilities message to LMF 570 indicating the position methods and features of these position methods that are supported by the UE 504 using LPP. The capabilities indicated in the LPP Provide Capabilities message may, in some aspects, indicate the type of positioning the UE 504 supports (e.g., DL-TDOA, RTT, E-CID, etc.) and may indicate the capabilities of the UE 504 to support those types of positioning.

Upon reception of the LPP Provide Capabilities message, at stage 520, the LMF 570 determines to use a particular type of positioning method (e.g., DL-TDOA, RTT, E-CID, etc.) based on the indicated type(s) of positioning the UE 504 supports and determines a set of one or more transmission-reception points (TRPs) from which the UE 504 is to measure downlink positioning reference signals or towards which the UE 504 is to transmit uplink positioning reference signals. At stage 530, the LMF 570 sends an LPP Provide Assistance Data message to the UE 504 identifying the set of TRPs.

In some implementations, the LPP Provide Assistance Data message at stage 530 may be sent by the LMF 570 to the UE 504 in response to an LPP Request Assistance Data message sent by the UE 504 to the LMF 570 (not shown in FIG. 5). An LPP Request Assistance Data message may include an identifier of the UE's 504 serving TRP and a request for the positioning reference signal (PRS) configuration of neighboring TRPs.

At stage 540, the LMF 570 sends a request for location information to the UE 504. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 530 may be sent after the LPP Request Location Information message at 540 if, for example, the UE 504 sends a request for assistance data to LMF 570 (e.g., in an LPP Request Assistance Data message, not shown in FIG. 5) after receiving the request for location information at stage 540.

At stage 550, the UE 504 utilizes the assistance information received at stage 530 and any additional data (e.g., a desired location accuracy or a maximum response time) received at stage 540 to perform positioning operations (e.g., measurements of DL-PRS, transmission of UL-PRS, etc.) for the selected positioning method.

At stage 560, the UE 504 may send an LPP Provide Location Information message to the LMF 570 conveying the results of any measurements that were obtained at stage 550 (e.g., time of arrival (ToA), reference signal time difference (RSTD), reception-to-transmission (Rx-Tx), etc.) and before or when any maximum response time has expired (e.g., a maximum response time provided by the LMF 570 at stage 540). The LPP Provide Location Information message at stage 560 may also include the time (or times) at which the positioning measurements were obtained and the identity of the TRP(s) from which the positioning measurements were obtained. Note that the time between the request for location information at 540 and the response at 560 is the “response time” and indicates the latency of the positioning session.

The LMF 570 computes an estimated location of the UE 504 using the appropriate positioning techniques (e.g., DL-TDOA, RTT, E-CID, etc.) based, at least in part, on measurements received in the LPP Provide Location Information message at stage 560.

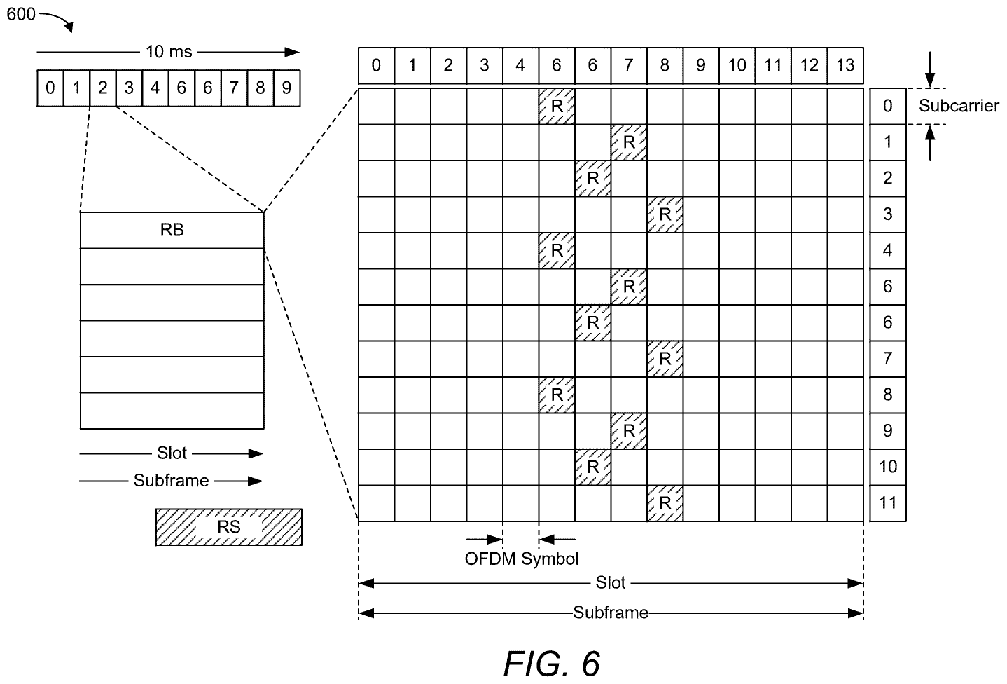

Various frame structures may be used to support downlink and uplink transmissions between network nodes (e.g., base stations and UEs). FIG. 6 is a diagram 600 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6, a numerology of 15 kHz is used. Thus, in the time domain, a 10 ms frame is divided into 10 equally sized subframes of 1 ms each, and each subframe includes one time slot. In FIG. 6, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 6 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 6); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

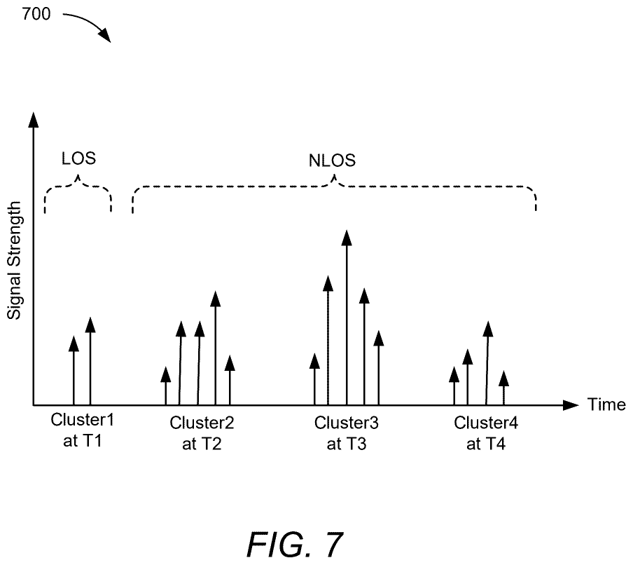

FIG. 7 is a graph 700 representing the channel impulse response of a multipath channel between a receiver device (e.g., any of the UEs or base stations described herein) and a transmitter device (e.g., any other of the UEs or base stations described herein), according to aspects of the disclosure. The channel impulse response represents the intensity of a radio frequency (RF) signal received through a multipath channel as a function of time delay. Thus, the horizontal axis is in units of time (e.g., milliseconds) and the vertical axis is in units of signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 7, the receiver detects/measures multiple (four) clusters of channel taps. Each channel tap represents a multipath that an RF signal followed between the transmitter and the receiver. That is, a channel tap represents the arrival of an RF signal on a multipath. Each cluster of channel taps indicates that the corresponding multipaths followed essentially the same path, and therefore, each cluster of channel taps corresponds to a path. There may be different clusters due to the RF signal being transmitted on different transmit beams (and therefore at different angles), or because of the propagation characteristics of RF signals (e.g., potentially following different paths due to reflections), or both.

All of the clusters of channel taps for a given RF signal represent the multipath channel (or simply channel) between the transmitter and receiver. Under the channel illustrated in FIG. 7, the receiver receives a first cluster (first path) of two RF signals on channel taps at time T1, a second cluster (second path) of five RF signals on channel taps at time T2, a third cluster (third path) of five RF signals on channel taps at time T3, and a fourth cluster (fourth path) of four RF signals on channel taps at time T4. In the example of FIG. 7, because the first cluster of RF signals at time T1 arrives first, it is assumed to correspond to the RF signal transmitted on the transmit beam aligned with the line-of-sight (LOS), or the shortest, path. The third cluster at time T3 is comprised of the strongest RF signals, and may correspond to, for example, the RF signal transmitted on a transmit beam aligned with a non-line-of-sight (NLOS) path. Note that although FIG. 7 illustrates clusters of two to five channel taps, as will be appreciated, the clusters may have more or fewer than the illustrated number of channel taps. Similarly, while FIG. 7 illustrates four clusters/paths, as will be appreciated, there may be more or fewer than four.

A network operator may be mandated to crosscheck the UE location reported by a UE in order to fulfil regulatory requirements regarding a network-verified UE location (e.g., lawful intercept, emergency calls, public warning systems, etc.). That is, the network operator should be able to check a UE's reported location information by, for example, estimating the UE's location at the network side, and to specify whether a mechanism is needed to fulfil the regulatory requirements. To determine a network-verified UE location for NTN-, an NTN-capable UE may report its global navigation satellite system (GNSS) location (as NTN-capable UEs are required to have GNSS), and the network (e.g., a location server) may verify or refine the UE's GNSS report through a network-assisted positioning technique.

One mechanism for using NTN transmitters (e.g., SVs 112) to estimate the location of a UE is frequency difference of arrival (FDOA), or differential Doppler (DD). FDOA is a technique analogous to TDOA for estimating the location of a UE based on measurements by the UE of multiple anchors (e.g., different NTN transmitters with known locations), or of the same anchor at multiple locations (e.g., the same non-geosynchronous NTN transmitter). TDOA and FDOA can be used together to improve location accuracy, insofar as TDOA can be used for positioning estimation using multiple anchors, while FDOA can be used for Doppler estimation whenever there is relative motion between a UE and the anchor(s) (Doppler is the change in frequency of an electromagnetic wave in relation to an observer that is moving relative to the wave's source). By combining TDOA and FDOA measurements, instantaneous positioning of a UE can be performed in two dimensions.

In a DL-FDOA positioning method using NTN transmitters (e.g., satellites), the UE's location can be estimated based on measurements taken at the UE of the difference in frequency, or frequency offset, between downlink radio signals from a single satellite emitted at different time instants, or of downlink radio signals from multiple satellites, along with the knowledge of the ephemeris of the satellites (i.e., the trajectory, or position and velocity, of the satellites over time).

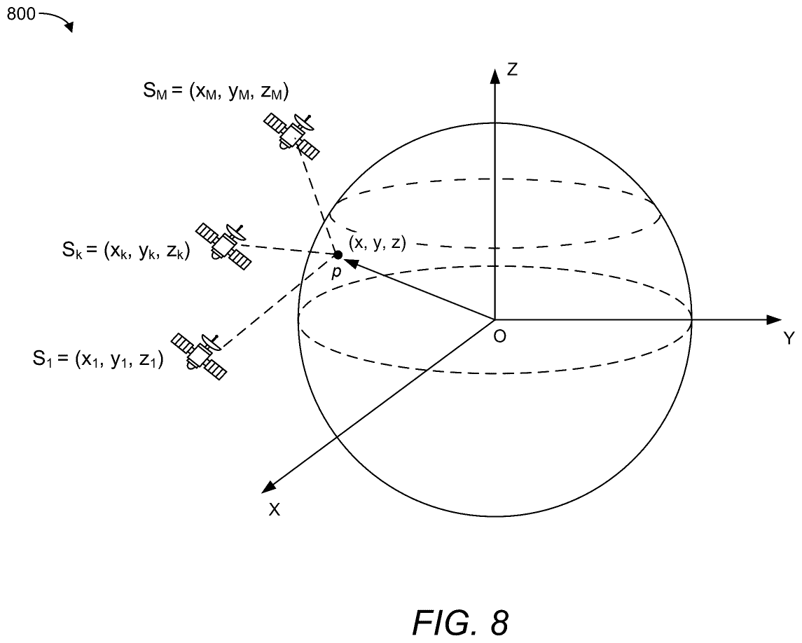

FIG. 8 is a diagram 800 illustrating an example system geometry for an FDOA positioning procedure, according to aspects of the disclosure. In the example of FIG. 8, a target UE is located at a fixed position (x, y, z) to be estimated, denoted p. In the case of a single satellite and a fixed UE, multiple virtual anchor locations can be created by the satellite transmitting PRS at M different instants in time. Alternatively, M satellites may transmit PRS at the same instant in time. The M satellite locations (whether locations of one satellite or multiple satellites) can be denoted as sᵢ (i=1, 2, . . . , M), and the velocities as \dot{s}_{ι}. Then the TDOA and FDOA can be expressed as the following system of equations:

$${d}_{i , 1} = {d}_{i} - {d}_{1} = {ct}_{i , 1} = ‖ {s}_{i} - p ‖ , i = 2 , 3 , … , M ,$$

$$\frac{\partial {d}_{i , 1}}{\partial t} = c {\dot{t}}_{i , 1} = \frac{\partial {d}_{i}}{\partial t} - \frac{\partial {d}_{1}}{\partial t} = \frac{{( {s}_{i} - p )}^{T} {\dot{s}}_{i}}{{d}_{i}} , i = 2 , 3 , … , M$$

In the example of FIG. 8, TDOA and FDOA may both be used to improve the positioning accuracy, in spite of the poor geometric dilution of precision (GDOP) due to lower diversity of anchor locations.

There is a significant Doppler shift (and thus frequency offset) in the signals emitted by NTN transmitters (e.g., satellites) that can be leveraged for positioning purposes. Table 1 provides a summary of Doppler shifts and shift variations for different altitudes of satellites.

TABLE 1

| | | | | Max. Doppler | | |
|---|---|---|---|---|---|---|
| Frequency | | | Relative | Shift | | |
| (GHz) | Max. Doppler | | Doppler | Variation | | |
| 2 | +/−48 | kHz | 0.0024% | −544 | Hz/s | Low-Earth |
| 20 | +/−480 | kHz | 0.0024% | −5.44 | kHz/s | orbit (LEO) at |
| 30 | +/−720 | kHz | 0.0024% | −8.16 | kHz/s | 600 kilometers |
| | | | | | | (km) altitude |
| 2 | +/−40 | kHz | 0.002% | −180 | Hz/s | LEO at 1,500 |
| 20 | +/−400 | kHz | 0.002% | −1.8 | kHz/s | km altitude |
| 30 | +/−600 | kHz | 0.002% | −2.7 | kHz/s | |
| 2 | +/−15 | kHz | 0.00075% | −6 | Hz/s | Medium Earth |
| 20 | +/−150 | kHz | 0.00075% | −60 | Hz/s | orbit (MEO) at |
| 30 | +/−225 | kHz | 0.00075% | −90 | Hz/s | 10,000 km |

altitude

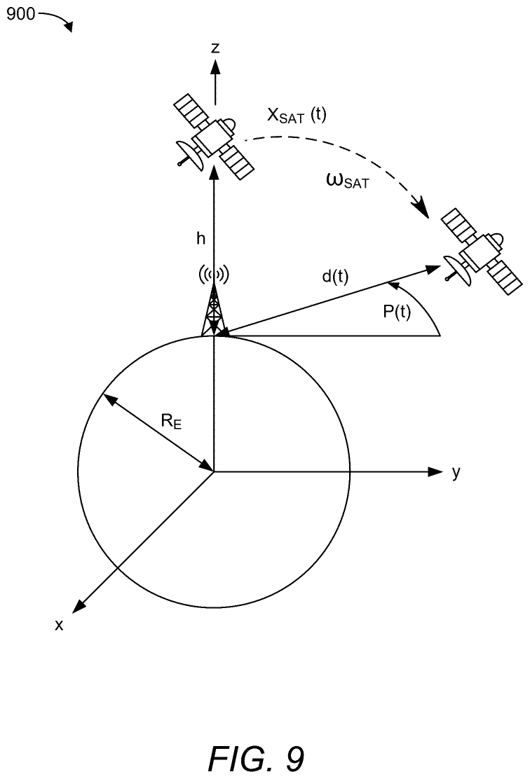

There are known techniques to address the Doppler shift of radio signals emitted by satellites. FIG. 9 is a diagram 900 illustrating system geometry for Doppler shift computation for a non-geostationary satellite system, according to aspects of the disclosure. The scenario illustrated in FIG. 9 assumes a Cartesian coordinate system such that the moving satellite and the receiver (e.g., a UE, terrestrial base station) are on the y-z plane. The Doppler shift experienced by a stationary receiver can be computed as follows as a function of time:

$${f}_{d} ( t ) = \frac{{f}_{0}}{c} \frac{d ( t )}{\vert d ( t ) \vert} \frac{\partial {x}_{SAT} ( t )}{\partial t}$$

where f₀ is the carrier frequency, d (t) is the distance vector between the satellite and the receiver, and x_{SAT}(t) is the vector of the satellite position. These vectors can be expressed as:

$$d ( t ) = {[ 0 ( {R}_{E} + h ) sin ( {ω}_{SAT} t ) ( {R}_{E} + h ) cos ( {ω}_{SAT} t ) - {R}_{E} ]}^{T}$$

$${x}_{SAT} ( t ) = {[ 0 ( {R}_{E} + h ) sin ( {ω}_{SAT} t ) ( {R}_{E} + h ) cos ( {ω}_{SAT} t ) ]}^{T}$$

where R_{E} is the Earth radius, h is the satellite altitude, and ω_{SAT} is the satellite angular velocity.

After some mathematical manipulation, the Doppler shift as a function of the elevation angle can be computed in a closed-form expression as follows:

$${f}_{d} ( t ) = \frac{{f}_{0}}{c} {ω}_{SAT} {R}_{E} cos [ θ ( t ) ]$$

where the angular velocity is

$${ω}_{SAT} = \sqrt{\frac{{GM}_{E}}{{( {R}_{E} + h )}^{3}}} ,$$

with G the gravitational constant and ME where the angular velocity is the Earth mass.

If the receiver (e.g., a UE) is placed on board an aircraft or a high-speed train, there will be an additional term of Doppler shift resulting from its own velocity. In the case of non-geostationary satellites, the Doppler shift due to satellite movement is much higher than the one caused by the receiver's movement. For geostationary earth orbiting (GEO) and high-altitude platform station (HAPS), the Doppler shift component is mainly caused by the receiver's movement.

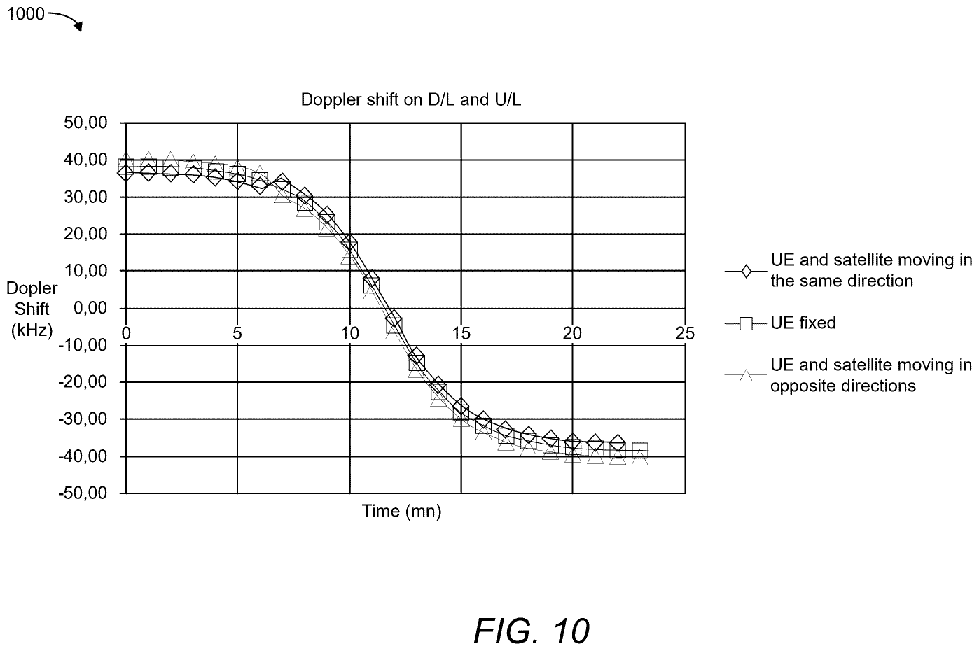

FIG. 10 is a graph 1000 illustrating an example Doppler shift scenario with a two GHz signal at 600 km on the downlink and uplink, according to aspects of the disclosure. Graph 1000 illustrates plots for both a fixed UE and UEs in motion (both moving in the same direction as the satellite and in the opposite direction as the satellite).

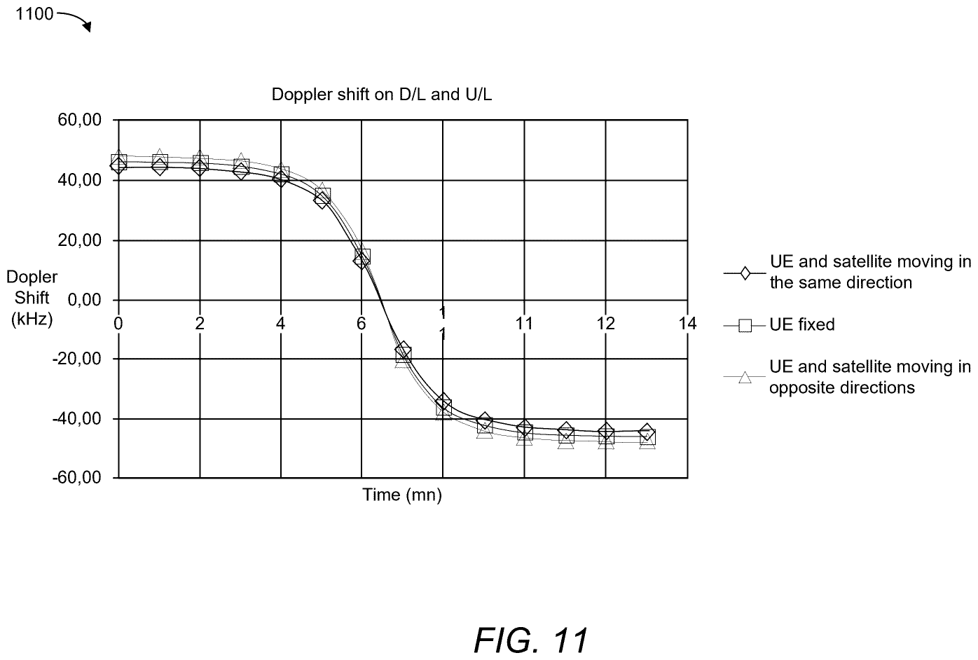

FIG. 11 is a graph 1100 illustrating an example Doppler shift scenario with a two GHz signal at 1500 km on the downlink and uplink, according to aspects of the disclosure. Graph 1100 illustrates plots for both a fixed UE and UEs in motion (both moving in the same direction as the satellite and in the opposite direction as the satellite).

Graphs 1000 and 1100 illustrate the worst-case impact for a UE moving at 1000 km/h, and moving in the same direction as the satellite (which is a non-geostationary satellite). The bounds of the graphs can be defined by adding the Doppler shift due to the satellite motion and the Doppler shift due to the UE motion. Graphs 1000 and 1100 clearly show the boundaries of the Doppler shift depending on the sense of motion between the satellite and the UE.

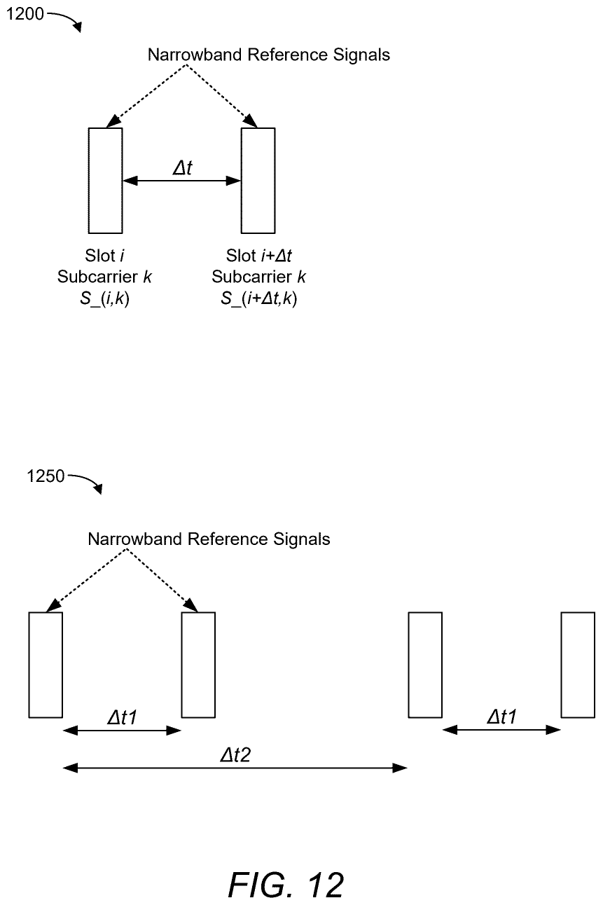

Doppler can be estimated based on properties of the measured reference signals. Referring first to time domain correlation, FIG. 12 illustrates determining time domain correlation among narrowband reference signals, according to aspects of the disclosure. In diagram 1200, a first symbol S_{i,k} (denoted “S_(i,k)”) belonging to a first narrowband reference signal (e.g., narrowband PRS) is transmitted in a first slot, Slot i, on subcarrier k. A second symbol S_{i+Δt,k} (denoted “S_(i+Δt,k)”) belonging to a second narrowband reference signal is transmitted in a second slot, Slot i+Δt, where Δ is the subcarrier spacing. Denoting the received symbols as R_{i,k} and R_{i+Δt,k}, respectively, and assuming a single-tap channel, z(k)=R_{i+Δt,k}(k)R*_{i,k}(k)S*_{i+Δt,k}(k)S_{i,k}(k).

Assuming the same power across all pilot tones, the phase difference, or phase shift, between two slots can be estimated as:

$$Δϕ = arg ( {{\sum }_{k}}^{} z ( k ) )$$

Reference signals separated by Δt₁, as shown in diagram 1200, can be used to determine the coarse Doppler estimate (\hat{f}_{D}). Specifically, the coarse Doppler can be estimated as:

$${\hat{f}}_{D} = \frac{1}{2 π Δ t} ( Δϕ \pm 2 l π )$$

$${f}_{D} ∼ 1 / Δ t$$

Note that because the phase is wrapped around, for the correct estimation of Doppler, the Doppler range (i.e., maximum and minimum Doppler) may be needed.

Diagram 1250 illustrates an iterative estimation to determine a fine Doppler estimate. To obtain a fine Doppler estimate, the receiving UE may apply coarse Doppler correction on the reference signal at i+Δt₂ as r(i+Δt₂)←r(i+Δt₂)e^{-j2π\hat{f}}^{_{D}}^{Δt}^{₂} and estimate the residual Doppler.

Referring to time-frequency correlation among reference signals for a multipath channel with K paths:

$$x ( t ) = {\sum }_{m = 0}^{M - 1} {\sum }_{n = 0}^{N - 1} S ( m , n ) {e}^{j 2 π tn Δ f} rect ( \frac{t - mT}{T} )$$

In the above equation, x(t) is _the transmitted baseband signal, M is the number of symbols, N is the number of subcarriers, S(m, n) is the reference signal pattern in the time-frequency resource grid (e.g., an example of which is shown in FIG. 6), and Tis the duration of an OFDM symbol.

Assuming that there are K paths (e.g., K=4 in the example of FIG. 7), the signal from the k-th path suffers a delay

$${τ}_{k} = \frac{{r}_{k}}{c}$$

### and a Doppler of

$${f}_{{D}_{k}} = \frac{{v}_{k} {f}_{c}}{c} .$$

The received signal in the time domain is represented as:

$$y ( t ) = {\sum }_{k = 1}^{K} {\sum }_{m = 0}^{M - 1} {\sum }_{n = 0}^{N - 1} {g}_{k} S ( m , n ) {e}^{j 2 π {tf}_{{D}_{k}}} {e}^{j 2 π n Δ f ( t - {τ}_{k} )} + η ( t ) .$$

In the above equation, gₖ is the complex gain of the k-th path and η(t) is additive white Gaussian noise (AWGN).

The channel matrix can be estimated as:

$${D}_{r} ( m , n ) = {\sum }_{k = 1}^{K} {g}_{k} {e}^{j 2 π ( {Tf}_{{D}_{k}} m - n Δ f {τ}_{k} )} + η$$

From this stage, the delay-Doppler of the K paths can be jointly estimated by discrete Fourier transform (DFT) methods, or subspace-based methods (e.g., MUSIC, ESPIRIT, etc.).

Various reference signal design principles are relevant to determining the delay-Doppler estimation from reference signals. Specifically, the range resolution is correlated to the inverse of the SCS, multiplied by the gap between pilot tones in the frequency domain, multiplied by the inverse of the number of pilot tones in the frequency domain. The velocity resolution is correlated to the SCS in parts-per-million (ppm), multiplied by the gap between the pilot tones in the time domain, multiplied by the inverse of the number of pilot signals coherently processed. The maximum unambiguous range is correlated to the inverse of the gap between pilot tones in the frequency domain. The maximum unambiguous velocity is correlated to the SCS in ppm multiplied by the inverse of the gap between pilot tones in the time domain.

For both NR PRS and LTE PRS, phase coherency is not guaranteed. However, phase coherency is important for Doppler estimation, which is an important RF sensing measurement. The following options could be considered for a PRS phase coherency indication in the assistance data provided to a UE for a positioning session. As a first option, by default, PRS phase coherency is not guaranteed. The assistance data could therefore indicate a group of PRS (e.g., PRS resources, resource sets, etc.) with phase coherency. A UE could then use the group of PRS for measuring and reporting Doppler.

As a second option, the assistance data may indicate specific TRPs that can support PRS phase coherency. The assistance data may also indicate a specific group of PRS (e.g., PRS resources, resource sets, etc.) associated with that TRP that could support PRS phase coherency. This option may reduce the signaling overhead, as some TRPs may always support phase coherency. For example, a particular gNB vendor may support such a feature for some deployments.

As a third option, the assistance data could indicate a specific frequency layer that could be used for RF sensing. Since Doppler is important information for most sensing use cases, the above indication implicitly indicates that the PRS configured under that specific frequency layer by default support Doppler estimation. The assistance data may indicate the PRS that may not support Doppler estimation (e.g., due to hardware limitations, phase coherence may be challenging for two PRS that are far away in the time domain).

Some gNB vendors may not support phase-coherent PRS transmission. In that case, the following options could be considered to enable Doppler estimation. As a first option, the assistance data could indicate an associated downlink reference signal for Doppler estimation, for example, TRS. The association between the PRS and the other downlink reference signal for Doppler estimation could be implemented by a QCL Type A, B, and/or C configuration. The associated downlink reference signal could be a narrowband reference signal, but should be configured close to the PRS in the time domain. TRS may be the preferred reference signal candidate, as it should support Doppler estimation.

As a second option, the assistance data may indicate an associated non-NR signal for Doppler estimation, such as a radar waveform. This assumes PRS and its associated radar waveform are transmitted from transmitters that are co-located, or even by the same transmitter. The assistance data may also include the configuration of the radar waveform (such as waveform type, parameters, etc.).

Based on the sensing measurement(s) collected at the location server, the location server may also signal the following assistance data for the search window selection for Doppler estimation: expected Doppler and expected Doppler uncertainty. The location server may define multiple sets of “ExpectedDoppler” and “ExpectedDoppler-Uncertaininty” for the same PRS or group of PRS. If the assistance data is UE-specific, each set of “ExpectedDoppler” and “ExpectedDoppler-Uncertaininty” could be associated with the path index (i.e., the channel impulse response tap index relative to the first arrival path, e.g., the path received at time T1 in FIG. 7).

Note that if the sensing receiver is a gNB, there should be corresponding assistance data signaling between the location server and the receiving gNB (e.g., via NR positioning protocol type A (NRPPa)).

While using PRS for Doppler measurements has been introduced, the procedures for UE measurement and reporting to the location server have not been defined. Accordingly, the present disclosure provides a definition for the phase measurement to be performed by the UE, a definition of the frequency offset to be reported by the UE for an FDOA positioning procedure, method(s) of measuring the frequency offset from PRS, the PRS configuration, the UE capability signaling, the positioning method(s) (in addition to DL-TDOA, multi-RTT, GNSS, etc.), and the method(s) of UE reporting of the frequency offset to the location server.

The present disclosure defines a DL PRS received path phase (denoted “RSRPPh”) measurement as the linear average (∠) of the phase of the channel response x (n) at the n-th path delay of the resource elements that carry the DL PRS configured for the measurement, where the DL PRS RSRPPh for the first path delay is the phase corresponding to the first detected path in time (e.g., the path received at time T1 in FIG. 7). That is, for any n, the path RSRPPh can be defined as:

$$∠ x ( n ) = ∠ \frac{1}{n} {\sum }_{k = 0}^{N - 1} X ( k ) {e}^{\frac{j 2 π kn}{N}}$$

In the foregoing equation, N is the number of subcarriers carrying PRS within an OFDM symbol and X(k) is received symbol at k-th subcarrier. If n=0, which

$$∠ x ( 0 ) = ∠ \frac{1}{N} {\sum }_{k = 0}^{N - 1} X ( k ) .$$

Based on the above definition for phase measurements (i.e., RSRPPh), a frequency offset measurement may be defined as:

$$\frac{DL PRS RSRPPh ( i ) - DL PRS RSRPPh ( j )}{2 πΔ}$$

In the above equation, i and j are symbol indices within a PRS resource where the allocation of PRS resource elements is the same. The variables i and j should be separated by at least one symbol so that i is not equal to j. The variables i and j may be within the same comb structure provided the resource allocation over frequency is the same. The variable A is the time difference between i and j. Frequency offset measurements may be taken within the same slot (intra-slot) or across slots (inter-slot). For intra-slot frequency offset measurements, i and j belong to the same slot and Δ=(i−j)Tₛ, where Tₛ is the number of OFDM symbols. For inter-slot frequency offset measurements, i and j belong to different slots and Δ=(i−j)Tₛ+Tₛₗₒₜ, where Tₛ is the number of OFDM symbols and Tₛₗₒₜ is the number of slots.

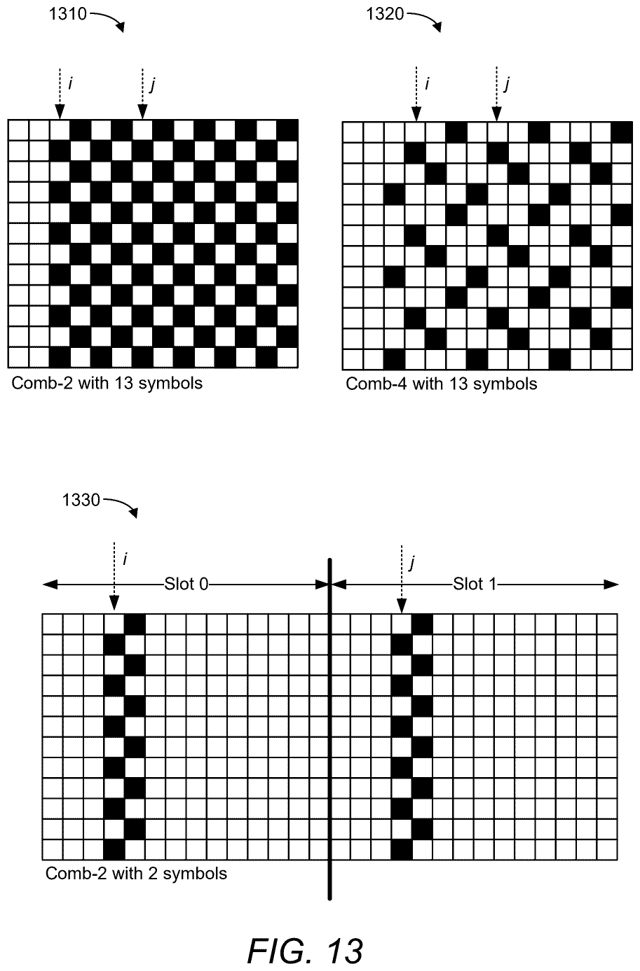

FIG. 13 illustrates examples of intra-slot and inter-slot frequency offset measurements, according to aspects of the disclosure. Specifically, diagrams 1310 and 1320 illustrate intra-slot frequency offset measurements and diagram 1330 illustrates an inter-slot frequency offset measurement. In FIG. 13, time is represented horizontally and frequency is represented vertically. Each large block represents a resource block and each small block represents a resource element. As discussed above, a resource element consists of one symbol in the time domain and one subcarrier in the frequency domain. In the example of FIG. 13, each resource block comprises 14 symbols in the time domain and 13 subcarriers in the frequency domain. The shaded resource elements carry, or are scheduled to carry, DL-PRS. As such, the shaded resource elements in each resource block correspond to a PRS resource, or the portion of the PRS resource within one resource block (since a PRS resource can span multiple resource blocks in the frequency domain).

As shown in FIG. 13, i and j are selected such that the allocation of PRS resource elements in the corresponding OFDM symbols is the same. Note that the locations of i and j in diagrams 1310, 1320, and 1330 are examples, and the disclosure is not limited to these symbols.

To accurately measure the frequency offset between i and j, the UE needs to process the PRS resource elements at symbols i and j coherently. That is, phase coherence needs to be maintained across the PRS resource elements of symbols i and j.

There are various options for configuring a UE to perform the frequency offset measurement between i and j. As a first option, a UE may measure the frequency offset between the PRS symbols at i and j using two different DL-PRS resources. That is, in the equation above, i and j would belong to PRS resources with different resource identifiers. For example, referring to FIG. 13, the PRS resources in slots 0 and 1 of diagram 1330 may be different PRS resources with the same comb pattern. As a second option, a UE may measure the frequency offset between the PRS symbols at i and j using one DL-PRS resource (a single occasion). That is, i and j in the above equation would belong to PRS resources having the same PRS resource identifier and scheduled during the same occasion. Diagrams 1310 and 1320 of FIG. 13 are examples of this option.

The UE could indicate its capability for PRS processing according to the first option (measuring the frequency offset using two different DL-PRS resources) or the second option (measuring the frequency offset using one DL-PRS resource) to the location server. Note that for the first option, the UE needs to process two DL-PRS resources coherently (i.e., with phase coherence). In this case, the location server may need to indicate to the UE a list of PRS resource IDs per TRP per frequency layer for which phase coherence may be assumed during a frequency offset measurement. For the second option, phase coherence between DL-PRS symbols within the same PRS resource may be implicitly assumed, thereby foregoing the need for additional signaling. However, phase coherence between PRS symbols in different slots (e.g., when comb patterns are repeated across slots) would need to be signaled to the UE. For example, the location server may indicate to the UE that the UE may assume coherent processing starting from every even slot number up to N slots.

Because a UE needs to coherently process the PRS symbols at i and j to obtain the frequency offset measurement, and because i and j may span multiple symbols of a single slot or multiple slots, a parameter is needed to indicate the number of symbols or number of slots between i and j. In addition, since the UE may only use one DL-PRS resource for the second option above, the present disclosure provides intra-slot repetition of the PRS comb pattern.

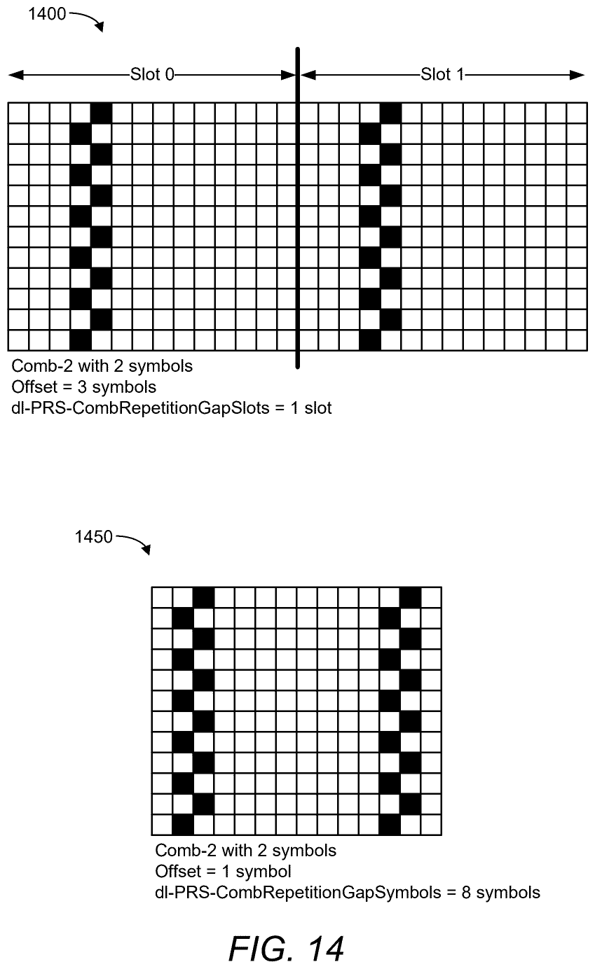

FIG. 14 illustrates examples of intra-slot and inter-slot comb pattern repetition, according to aspects of the disclosure. In FIG. 14, time is represented horizontally and frequency is represented vertically. Each large block represents a resource block and each small block represents a resource element. The shaded resource elements carry, or are scheduled to carry, DL-PRS. As such, the shaded resource elements in each resource block correspond to a PRS resource, or the portion of the PRS resource within one resource block (since a PRS resource can span multiple resource blocks in the frequency domain).

Diagram 1400 illustrates an example of inter-slot repetition of the comb pattern and diagram 1450 illustrates an example of intra-slot repetition of the comb pattern. For inter-slot repetition, a UE may be configured with a repetition gap between i and j as a number of slots. For example, the location server or serving base station may configure the UE with a “dl-PRS-CombRepetitionGapSlots” parameter that indicates a duration of slots (e.g., the number of slots) between the repeated comb pattern (one slot in the example of FIG. 14). For intra-slot repetition, a UE may be configured with the repetition gap as a number of symbols within a slot. For example, the location server or serving base station may configure the UE with a “dl-PRS-CombRepetitionGapSymbols” parameter that indicates a duration of symbols (e.g., the number of symbols) between the repeated comb pattern within the slot (eight symbols in the example of FIG. 14). Both types of repetition gap parameters indicate to the UE that it needs to coherently process the symbols separated by the signaled repetition gap.

To support the addition of new positioning procedures, such as DL-FDOA positioning procedures, LPP signaling can be expanded to include the necessary signaling (e.g., assistance data, measurement reports, etc.) between the location server and the UE. Alternatively, the current DL-TDOA LPP framework can be used for DL-FDOA positioning procedures. In this case, the location server may request and/or the UE may report the frequency offset between a reference TRP and one or more neighboring TRPs. As yet another alternative, the assistance data for DL-FDOA positioning may be broadcasted by a base station (terrestrial or non-terrestrial) in one or more positioning SIBs (posSIBs). As with LPP assistance data for DL-FDOA, the currently defined posSIB(s) carrying assistance data for TDOA positioning may be extended to include the assistance data for DL-FDOA positioning, or a posSIB dedicated to DL-FDOA may be broadcasted. In an aspect, a location server may direct a base station to broadcast posSIBs carrying assistance data for DL-FDOA positioning and may provide the information to include in the posSIBs.

To support the techniques described herein, a UE may indicate new capabilities to the location server (e.g., in an LPP Provide Capabilities message), such as its ability to support a DL-FDOA positioning procedure, or its capability to perform frequency offset reporting (e.g., as a per-band reporting capability).

The PRS used for DL-FDOA positioning may have a different configuration then PRS configured for other types of positioning. For example, PRS for DL-FDOA may be narrowband and spread over time, whereas PRS for time-based positioning procedures (such as DL-TDOA) are generally wideband. In an aspect, a resource pool for such PRS (e.g., narrowband) could be designated separately from the legacy (e.g., wideband) PRS resource pool. In such a case, the UE can separately indicate its capability for processing narrowband PRS resources.

Currently, a UE uses the higher layer (e.g., LPP) information element “NR-DL-PRS-ProcessingCapability” to report to the location server its PRS processing capabilities. The following is a table of various fields of the “NR-DL-PRS-ProcessingCapability” information element. A UE may indicate the same or different values of the following capabilities for narrowband PRS processing as for wideband PRS processing.

TABLE 2
NR-DL-PRS-ProcessingCapability field descriptions

maxSupportedFreqLayers
Indicates the maximum number of positioning frequency layers supported by UE.
supportedBandwidthPRS
Indicates the maximum number of DL-PRS bandwidth in MHz, which is supported and
reported by UE.
dl-PRS-BufferType
Indicates DL-PRS buffering capability. Value “type1” indicates sub-slot/symbol level
buffering and value type2 indicates slot level buffering.
durationOfPRS-Processing
Indicates the duration N of DL-PRS symbols in units of ms a UE can process every T
ms assuming maximum DL-PRS bandwidth provided in “supportedBandwidthPRS”
and comprises the following subfields:
durationOfPRS-ProcessingSymbols: This field specifies the values for N.
Enumerated values indicate 0.125, 0.25, 0.5, 1, 2, 4, 8, 12, 16, 20, 25, 30, 35, 40,
45, 50 ms.
durationOfPRS-ProcessingSymbolsInEveryTms: This field specifies the values
for T. Enumerated values indicate 8, 16, 20, 30, 40, 80, 160, 320, 640, 1280 ms.
maxNumOfDL-PRS-ResProcessedPerSlot
Indicates the maximum number of DL-PRS resources that UE can process in a slot.
SCS: 15 kHz, 30 kHz, 60 kHz are applicable for FR1 bands. SCS: 60 kHz, 120 kHz are
applicable for FR2 bands.
simulLTE-NR-PRS
Indicates whether the UE supports parallel processing of LTE PRS and NR PRS.

Note that when the target UE provides the “durationOfPRS-Processing” capability (N, T) for any P(≥T) time window, the target UE should be capable of processing all DL-PRS resources within P, if (1) N≥K, where K is defined in the 3GPP Technical Specificayion (TS) 38.214, and (2) the number of DL-PRS Resources in each slot does not exceed the “maxNumOfDL-PRS-ResProcessedPerSlot,” and (3) the configured measurement gap and a maximum ratio of measurement gap length (MGL)/measurement gap repetition period (MGRP) is as specified in 3GPP TS 38.133.

In an aspect, a UE can report frequency offset with respect to a reference TRP. As a first option, frequency offset measurements can be reported alongside RSTD measurements using, for example, one or more new fields in the higher layer (e.g., LPP) information element “NR-DL-TDOA-SignalMeasurementInformation.” As a second option, frequency offset measurements can be reported separately in one or more new higher layer (e.g., LPP) messages, such as a “FrequencyOffset-SignalMeasurementInformation” information element.

As a sub-aspect, a UE may report the frequency offset of the first dominant path (e.g., the path received at time T1 in FIG. 7) and additional frequency offsets for up to N additional paths (e.g., up to three additional paths in the example of FIG. 7). In this case, the UE can report its capability to report the first dominant path and its capability to report the up to N additional paths. In an aspect, N={1, 2, 4, 8}.

In an aspect, a UE may report the frequency offset(s) in different formats. In a first aspect, the UE may report normalized or unitless values of the frequency offset measurement(s) and/or subcarrier spacing, or report the values of the frequency offset(s) in ppm units (per TRP). In a second aspect, the UE may report (per TRP) the values of the frequency offset(s) in terms of velocity (e.g., in km/s). In a third aspect, the UE may report (per TRP per component carrier) the values of the frequency offset(s) in a frequency unit (e.g., Hertz). In a fourth aspect, the UE may report the difference between the observed/measured frequency offset and the expected frequency offset received from the location server (signaled to the UE based on the location server's estimate of the UE's location (e.g., the center of the serving beam)).

In an aspect, the frequency offset measurement range and resolution may be configured. The measurements may be in the range of [−M_{lb} fₛ, M_{ub} fₛ], where M_{lb} is the lower bound, M_{ub} is the upper bound, and fₛ is the sampling frequency. The resolution of measurement can be 2kfₛ, where kₘᵢₙ≤k≤kₘₐₓ, and k is the reporting granularity factor. M_{lb} and M_{ub} (and additionally k) can be (1) explicitly signaled to the UE by the location server per TRP, component carrier, frequency band, or frequency layer, (2) explicitly signaled by the location server to the UE per TRP in ppm units and the UE translates to per component carrier, per frequency band, or per frequency layer, or (3) implicitly assumed by the UE based on the orbit of the satellite TRP (e.g., LEO (or LEO-600 km, LEO-1200 km, etc.), MEO, or GEO).

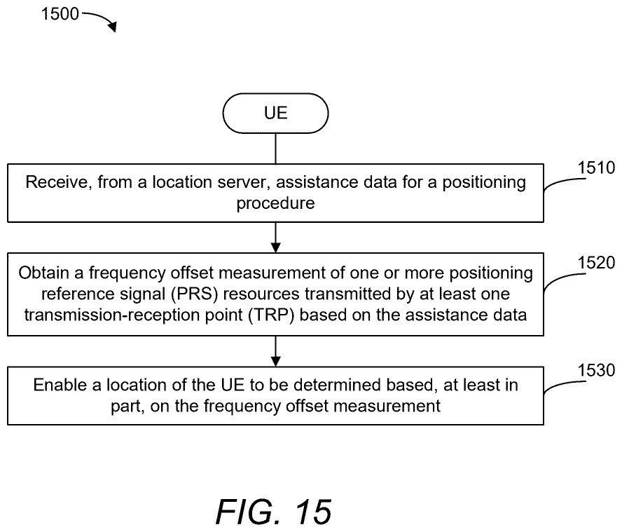

FIG. 15 illustrates an example method 1500 of wireless positioning, according to aspects of the disclosure. In an aspect, method 1500 may be performed by a UE (e.g., any of the UEs described herein).

At 1510, the UE receives, from a location server, assistance data for a positioning procedure (e.g., an FDOA or TDOA positioning procedure). In an aspect, operation 1510 may be performed by the one or more WWAN transceivers 310, the one or more processors 332, memory 340, and/or positioning component 342, any or all of which may be considered means for performing this operation.

At 1520, the UE obtains a frequency offset measurement of one or more PRS resources transmitted by at least one TRP (e.g., a space vehicle) based on the assistance data. In an aspect, operation 1520 may be performed by the one or more WWAN transceivers 310, the one or more processors 332, memory 340, and/or positioning component 342, any or all of which may be considered means for performing this operation.

At 1530, the UE enables a location of the UE to be determined based, at least in part, on the frequency offset measurement. In an aspect, operation 1530 may be performed by the one or more WWAN transceivers 310, the one or more processors 332, memory 340, and/or positioning component 342, any or all of which may be considered means for performing this operation.

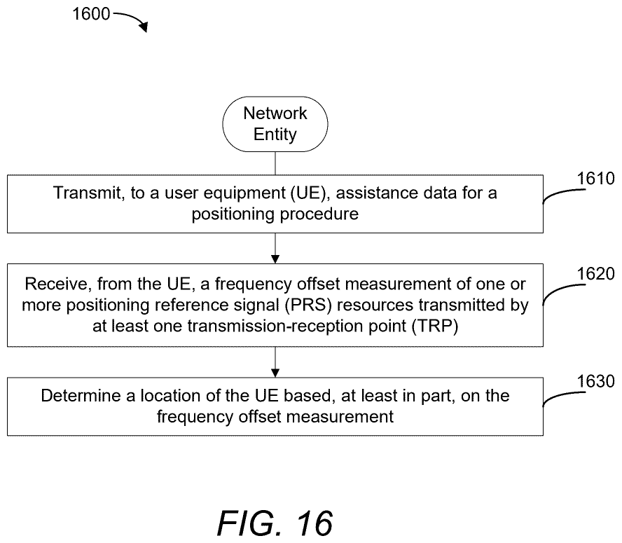

FIG. 16 illustrates an example method 1600 of positioning, according to aspects of the disclosure. In an aspect, method 1600 may be performed by a network entity (e.g., a location server).

At 1610, the network entity transmits, to a UE (e.g., any of the UEs described herein), assistance data for a positioning procedure (e.g., an FDOA or TDOA positioning procedure). In an aspect, operation 1610 may be performed by the one or more network transceivers 390, the one or more processors 394, memory 396, and/or positioning component 398, any or all of which may be considered means for performing this operation.

At 1620, the network entity receives, from the UE, a frequency offset measurement of one or more PRS resources transmitted by at least one TRP. In an aspect, operation 1620 may be performed by the one or more network transceivers 390, the one or more processors 394, memory 396, and/or positioning component 398, any or all of which may be considered means for performing this operation.

At 1630, the network entity determines a location of the UE based, at least in part, on the frequency offset measurement. In an aspect, operation 1610 may be performed by the one or more network transceivers 390, the one or more processors 394, memory 396, and/or positioning component 398, any or all of which may be considered means for performing this operation.

As will be appreciated, a technical advantage of the methods 1500 and 1600 is enabling positioning of a UE based on frequency offset measurements.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), comprising: receiving assistance data for a positioning procedure; obtaining a frequency offset measurement of one or more positioning reference signal (PRS) resources transmitted by at least one transmission-reception point (TRP) based on the assistance data; and enabling a location of the UE to be determined based, at least in part, on the frequency offset measurement.

Clause 2. The method of clause 1, wherein the frequency offset measurement is based on a first phase measurement of a first symbol of the one or more PRS resources, a second phase measurement of a second symbol of the one or more PRS resources, and a difference in time between the first symbol and the second symbol.

Clause 3. The method of clause 2, wherein the first symbol and the second symbol have the same allocation of PRS resource elements of the one or more PRS resources.

Clause 4. The method of any of clauses 2 to 3, wherein: the first symbol and the second symbol are within the same slot, and the difference in time indicates a number of symbols between the first symbol and the second symbol.

Clause 5. The method of clause 4, wherein: the one or more PRS resources are a single PRS resource, the single PRS resource comprises at least two repetitions of a comb pattern of the single PRS resource, and the at least two repetitions of the comb pattern are separated by the difference in time.

Clause 6. The method of any of clauses 2 to 3, wherein: the first symbol and the second symbol are in different slots, and the difference in time indicates a number of slots between the different slots.

Clause 7. The method of clause 6, wherein the one or more PRS resources in the different slots have the same comb pattern.

Clause 8. The method of any of clauses 2 to 7, wherein: the first symbol and the second symbol belong to the same PRS resource of the one or more PRS resources.

Clause 9. The method of any of clauses 2 to 7, wherein: the first symbol belongs to a first PRS resource of the one or more PRS resources, and the second symbol belongs to a second PRS resource of the one or more PRS resources different than the first PRS resource.

Clause 10. The method of clause 9, wherein the assistance data indicates that the first PRS resource and the second PRS resource are configured to be transmitted by the at least one TRP with phase coherence.

Clause 11. The method of any of clauses 2 to 10, further comprising: transmitting, to a location server, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 12. The method of any of clauses 2 to 11, wherein: the first phase measurement is a first phase of a first linear average of a first channel response of a first path delay of PRS resource elements of the first symbol of the one or more PRS resources, and the second phase measurement is a second phase of a second linear average of a second channel response of a second path delay of PRS resource elements of the second symbol of the one or more PRS resources.

Clause 13. The method of any of clauses 2 to 12, wherein the assistance data includes an index of the first symbol, an index of the second symbol, and the difference in time.

Clause 14. The method of any of clauses 1 to 13, further comprising: transmitting, to a location server, a capability message indicating a capability of the UE to engage in a frequency difference of arrival (FDOA) positioning procedure, to report the frequency offset measurement, or both.

Clause 15. The method of any of clauses 1 to 14, wherein the positioning procedure is an FDOA positioning procedure.

Clause 16. The method of any of clauses 1 to 15, wherein enabling the location of the UE to be determined comprises: reporting the frequency offset measurement to a location server to enable the location server to determine the location of the UE.

Clause 17. The method of clause 16, wherein: the positioning procedure is a time-difference of arrival (TDOA) positioning procedure, and the frequency offset measurement is reported to the location server as part of the TDOA positioning procedure.

Clause 18. The method of any of clauses 16 to 17, wherein reporting the frequency offset measurement comprises: reporting a first frequency offset measurement of a first dominant path of the one or more PRS resources; and reporting one or more second frequency offset measurements of one or more additional paths of the one or more PRS resources.

Clause 19. The method of clause 18, further comprising: transmitting, to the location server, a capability message indicating a capability of the UE to report the one or more second frequency offset measurements.

Clause 20. The method of any of clauses 1 to 15, wherein enabling the location of the UE to be determined comprises: determining the location of the UE based on the frequency offset measurement and ephemeris information for the at least one TRP.

Clause 21. The method of any of clauses 1 to 20, wherein the one or more PRS resources are one or more narrowband PRS resources.

Clause 22. The method of clause 21, further comprising: transmitting, to a location server, a capability message indicating a capability of the UE to obtain the frequency offset measurement based on the one or more narrowband PRS resources.

Clause 23. The method of any of clauses 1 to 22, wherein the frequency offset measurement is reported: as a normalized value without units, in units of parts-per-million (ppm), in units of velocity, in units of frequency, or as a difference between an actual frequency offset measurement obtained by the UE and an expected frequency offset measurement received in the assistance data.

Clause 24. The method of any of clauses 1 to 23, wherein the assistance data includes a range and resolution for reporting the frequency offset measurement per TRP, component carrier, frequency band, or frequency layer.

Clause 25. The method of any of clauses 1 to 24, wherein: the assistance data includes a range and resolution for reporting the frequency offset measurement per TRP in ppm units, and the UE translates the range and resolution to a range and resolution per component carrier, frequency band, or frequency layer.

Clause 26. The method of any of clauses 1 to 25, further comprising: determining a range and resolution of the frequency offset measurement based on an orbit of the at least one TRP.

Clause 27. The method of any of clauses 1 to 26, wherein the assistance data is received from: a location server in one or more Long-Term Evolution (LTE) positioning protocol (LPP) messages, or a base station in one or more positioning system information blocks (posSIBs) broadcasted by the base station.

Clause 28. The method of any of clauses 1 to 27, wherein the at least one TRP comprises at least one space vehicle.

Clause 29. A method of positioning performed by a network entity, comprising: transmitting, to a user equipment (UE), assistance data for a positioning procedure; receiving, from the UE, a frequency offset measurement of one or more positioning reference signal (PRS) resources transmitted by at least one transmission-reception point (TRP); and determining a location of the UE based, at least in part, on the frequency offset measurement.

Clause 30. The method of clause 29, wherein the frequency offset measurement is based on a first phase measurement of a first symbol of the one or more PRS resources, a second phase measurement of a second symbol of the one or more PRS resources, and a difference in time between the first symbol and the second symbol.

Clause 31. The method of clause 30, wherein the first symbol and the second symbol have the same allocation of PRS resource elements of the one or more PRS resources.

Clause 32. The method of any of clauses 30 to 31, wherein: the first symbol and the second symbol are within the same slot, and the difference in time indicates a number of symbols between the first symbol and the second symbol.

Clause 33. The method of clause 32, wherein: the one or more PRS resources are a single PRS resource, the single PRS resource comprises at least two repetitions of a comb pattern of the single PRS resource, and the at least two repetitions of the comb pattern are separated by the difference in time.

Clause 34. The method of any of clauses 30 to 31, wherein: the first symbol and the second symbol are in different slots, and the difference in time indicates a number of slots between the different slots.

Clause 35. The method of clause 34, wherein the one or more PRS resources in the different slots have the same comb pattern.

Clause 36. The method of any of clauses 30 to 35, wherein: the first symbol and the second symbol belong to the same PRS resource of the one or more PRS resources.

Clause 37. The method of any of clauses 30 to 35, wherein: the first symbol belongs to a first PRS resource of the one or more PRS resources, and the second symbol belongs to a second PRS resource of the one or more PRS resources different than the first PRS resource.

Clause 38. The method of clause 37, wherein the assistance data indicates that the first PRS resource and the second PRS resource are configured to be transmitted by the at least one TRP with phase coherence.

Clause 39. The method of any of clauses 30 to 38, further comprising: receiving, from the UE, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 40. The method of any of clauses 30 to 39, wherein the assistance data includes an index of the first symbol, an index of the second symbol, and the difference in time.

Clause 41. The method of any of clauses 29 to 40, further comprising: receiving, from the UE, a capability message indicating a capability of the UE to engage in a frequency difference of arrival (FDOA) positioning procedure, to report the frequency offset measurement, or both.

Clause 42. The method of any of clauses 29 to 41, wherein the positioning procedure is an FDOA positioning procedure.

Clause 43. The method of any of clauses 29 to 42, wherein: the positioning procedure is a time-difference of arrival (TDOA) positioning procedure, and the frequency offset measurement is received from the UE as part of the TDOA positioning procedure.

Clause 44. The method of any of clauses 29 to 43, wherein receiving the frequency offset measurement comprises: receiving a first frequency offset measurement of a first dominant path of the one or more PRS resources; and receiving one or more second frequency offset measurements of one or more additional paths of the one or more PRS resources.

Clause 45. The method of clause 44, further comprising: receiving, from the UE, a capability message indicating a capability of the UE to report the one or more second frequency offset measurements.

Clause 46. The method of any of clauses 29 to 45, wherein the one or more PRS resources are one or more narrowband PRS resources.

Clause 47. The method of clause 46, further comprising: receiving, from the UE, a capability message indicating a capability of the UE to obtain the frequency offset measurement based on the one or more narrowband PRS resources.

Clause 48. The method of any of clauses 29 to 47, wherein the frequency offset measurement is received: as a normalized value without units, in units of parts-per-million (ppm), in units of velocity, in units of frequency, or as a difference between an actual frequency offset measurement obtained by the UE and an expected frequency offset measurement transmitted to the UE in the assistance data.

Clause 49. The method of any of clauses 29 to 48, wherein: the assistance data includes a range and resolution for reporting the frequency offset measurement per TRP, component carrier, frequency band, or frequency layer, or the assistance data includes a range and resolution for reporting the frequency offset measurement per TRP in ppm units.

Clause 50. The method of any of clauses 29 to 49, wherein transmitting the assistance data comprises: transmitting the assistance data in one or more Long-Term Evolution (LTE) positioning protocol (LPP) messages; or broadcasting the assistance data in one or more positioning system information blocks (posSIBs).

Clause 51. The method of any of clauses 29 to 50, wherein the at least one TRP comprises at least one space vehicle.

Clause 52. The method of any of clauses 29 to 51, wherein the network entity is a location server.

Clause 53. A user equipment (UE), comprising: a memory; at least one transceiver; and at least one processor communicatively coupled to the memory and the at least one transceiver, the at least one processor configured to: receive, via the at least one transceiver, assistance data for a positioning procedure; obtain a frequency offset measurement of one or more positioning reference signal (PRS) resources transmitted by at least one transmission-reception point (TRP) based on the assistance data; and enable a location of the UE to be determined based, at least in part, on the frequency offset measurement.

Clause 54. The UE of clause 53, wherein the frequency offset measurement is based on a first phase measurement of a first symbol of the one or more PRS resources, a second phase measurement of a second symbol of the one or more PRS resources, and a difference in time between the first symbol and the second symbol.

Clause 55. The UE of clause 54, wherein the first symbol and the second symbol have the same allocation of PRS resource elements of the one or more PRS resources.

Clause 56. The UE of any of clauses 54 to 55, wherein: the first symbol and the second symbol are within the same slot, and the difference in time indicates a number of symbols between the first symbol and the second symbol.

Clause 57. The UE of clause 56, wherein: the one or more PRS resources are a single PRS resource, the single PRS resource comprises at least two repetitions of a comb pattern of the single PRS resource, and the at least two repetitions of the comb pattern are separated by the difference in time.

Clause 58. The UE of any of clauses 54 to 55, wherein: the first symbol and the second symbol are in different slots, and the difference in time indicates a number of slots between the different slots.

Clause 59. The UE of clause 58, wherein the one or more PRS resources in the different slots have the same comb pattern.

Clause 60. The UE of any of clauses 54 to 59, wherein: the first symbol and the second symbol belong to the same PRS resource of the one or more PRS resources.

Clause 61. The UE of any of clauses 54 to 59, wherein: the first symbol belongs to a first PRS resource of the one or more PRS resources, and the second symbol belongs to a second PRS resource of the one or more PRS resources different than the first PRS resource.

Clause 62. The UE of clause 61, wherein the assistance data indicates that the first PRS resource and the second PRS resource are configured to be transmitted by the at least one TRP with phase coherence.

Clause 63. The UE of any of clauses 54 to 62, wherein the at least one processor is further configured to: transmit, via the at least one transceiver, to a location server, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 64. The UE of any of clauses 54 to 63, wherein: the first phase measurement is a first phase of a first linear average of a first channel response of a first path delay of PRS resource elements of the first symbol of the one or more PRS resources, and the second phase measurement is a second phase of a second linear average of a second channel response of a second path delay of PRS resource elements of the second symbol of the one or more PRS resources.

Clause 65. The UE of any of clauses 54 to 64, wherein the assistance data includes an index of the first symbol, an index of the second symbol, and the difference in time.

Clause 66. The UE of any of clauses 53 to 65, wherein the at least one processor is further configured to: transmit, via the at least one transceiver, to a location server, a capability message indicating a capability of the UE to engage in a frequency difference of arrival (FDOA) positioning procedure, to report the frequency offset measurement, or both.

Clause 67. The UE of any of clauses 53 to 66, wherein the positioning procedure is an FDOA positioning procedure.

Clause 68. The UE of any of clauses 53 to 67, wherein the at least one processor configured to enable the location of the UE to be determined comprises the at least one processor configured to: report, via the at least one transceiver, the frequency offset measurement to a location server to enable the location server to determine the location of the UE.

Clause 69. The UE of clause 68, wherein: the positioning procedure is a time-difference of arrival (TDOA) positioning procedure, and the frequency offset measurement is reported to the location server as part of the TDOA positioning procedure.

Clause 70. The UE of any of clauses 68 to 69, wherein the at least one processor configured to report the frequency offset measurement comprises the at least one processor configured to: report, via the at least one transceiver, a first frequency offset measurement of a first dominant path of the one or more PRS resources; and report, via the at least one transceiver, one or more second frequency offset measurements of one or more additional paths of the one or more PRS resources.

Clause 71. The UE of clause 70, wherein the at least one processor is further configured to: transmit, via the at least one transceiver, to the location server, a capability message indicating a capability of the UE to report the one or more second frequency offset measurements.

Clause 72. The UE of any of clauses 53 to 67, wherein the at least one processor configured to enable the location of the UE to be determined comprises the at least one processor configured to: determine the location of the UE based on the frequency offset measurement and ephemeris information for the at least one TRP.

Clause 73. The UE of any of clauses 53 to 72, wherein the one or more PRS resources are one or more narrowband PRS resources.

Clause 74. The UE of clause 73, wherein the at least one processor is further configured to: transmit, via the at least one transceiver, to a location server, a capability message indicating a capability of the UE to obtain the frequency offset measurement based on the one or more narrowband PRS resources.

Clause 75. The UE of any of clauses 53 to 74, wherein the frequency offset measurement is reported: as a normalized value without units, in units of parts-per-million (ppm), in units of velocity, in units of frequency, or as a difference between an actual frequency offset measurement obtained by the UE and an expected frequency offset measurement received in the assistance data.

Clause 76. The UE of any of clauses 53 to 75, wherein the assistance data includes a range and resolution for reporting the frequency offset measurement per TRP, component carrier, frequency band, or frequency layer.

Clause 77. The UE of any of clauses 53 to 76, wherein: the assistance data includes a range and resolution for reporting the frequency offset measurement per TRP in ppm units, and the UE translates the range and resolution to a range and resolution per component carrier, frequency band, or frequency layer.

Clause 78. The UE of any of clauses 53 to 77, wherein the at least one processor is further configured to: determine a range and resolution of the frequency offset measurement based on an orbit of the at least one TRP.

Clause 79. The UE of any of clauses 53 to 78, wherein the assistance data is received from: a location server in one or more Long-Term Evolution (LTE) positioning protocol (LPP) messages, or a base station in one or more positioning system information blocks (posSIBs) broadcasted by the base station.

Clause 80. The UE of any of clauses 53 to 79, wherein the at least one TRP comprises at least one space vehicle.

Clause 81. A network entity, comprising: a memory; at least one transceiver; and at least one processor communicatively coupled to the memory and the at least one transceiver, the at least one processor configured to: transmit, via the at least one transceiver, to a user equipment (UE), assistance data for a positioning procedure; receive, via the at least one transceiver, from the UE, a frequency offset measurement of one or more positioning reference signal (PRS) resources transmitted by at least one transmission-reception point (TRP); and determine a location of the UE based, at least in part, on the frequency offset measurement.

Clause 82. The network entity of clause 81, wherein the frequency offset measurement is based on a first phase measurement of a first symbol of the one or more PRS resources, a second phase measurement of a second symbol of the one or more PRS resources, and a difference in time between the first symbol and the second symbol.

Clause 83. The network entity of clause 82, wherein the first symbol and the second symbol have the same allocation of PRS resource elements of the one or more PRS resources.

Clause 84. The network entity of any of clauses 82 to 83, wherein: the first symbol and the second symbol are within the same slot, and the difference in time indicates a number of symbols between the first symbol and the second symbol.

Clause 85. The network entity of clause 84, wherein: the one or more PRS resources are a single PRS resource, the single PRS resource comprises at least two repetitions of a comb pattern of the single PRS resource, and the at least two repetitions of the comb pattern are separated by the difference in time.

Clause 86. The network entity of any of clauses 82 to 83, wherein: the first symbol and the second symbol are in different slots, and the difference in time indicates a number of slots between the different slots.

Clause 87. The network entity of clause 86, wherein the one or more PRS resources in the different slots have the same comb pattern.

Clause 88. The network entity of any of clauses 82 to 87, wherein: the first symbol and the second symbol belong to the same PRS resource of the one or more PRS resources.

Clause 89. The network entity of any of clauses 82 to 87, wherein: the first symbol belongs to a first PRS resource of the one or more PRS resources, and the second symbol belongs to a second PRS resource of the one or more PRS resources different than the first PRS resource.

Clause 90. The network entity of clause 89, wherein the assistance data indicates that the first PRS resource and the second PRS resource are configured to be transmitted by the at least one TRP with phase coherence.

Clause 91. The network entity of any of clauses 82 to 90, wherein the at least one processor is further configured to: receive, via the at least one transceiver, from the UE, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 92. The network entity of any of clauses 82 to 91, wherein the assistance data includes an index of the first symbol, an index of the second symbol, and the difference in time.

Clause 93. The network entity of any of clauses 81 to 92, wherein the at least one processor is further configured to: receive, via the at least one transceiver, from the UE, a capability message indicating a capability of the UE to engage in a frequency difference of arrival (FDOA) positioning procedure, to report the frequency offset measurement, or both.

Clause 94. The network entity of any of clauses 81 to 93, wherein the positioning procedure is an FDOA positioning procedure.

Clause 95. The network entity of any of clauses 81 to 94, wherein: the positioning procedure is a time-difference of arrival (TDOA) positioning procedure, and the frequency offset measurement is received from the UE as part of the TDOA positioning procedure.

Clause 96. The network entity of any of clauses 81 to 95, wherein the at least one processor configured to receive the frequency offset measurement comprises the at least one processor configured to: receive, via the at least one transceiver, a first frequency offset measurement of a first dominant path of the one or more PRS resources; and receive, via the at least one transceiver, one or more second frequency offset measurements of one or more additional paths of the one or more PRS resources.

Clause 97. The network entity of clause 96, wherein the at least one processor is further configured to: receive, via the at least one transceiver, from the UE, a capability message indicating a capability of the UE to report the one or more second frequency offset measurements.

Clause 98. The network entity of any of clauses 81 to 97, wherein the one or more PRS resources are one or more narrowband PRS resources.

Clause 99. The network entity of clause 98, wherein the at least one processor is further configured to: receive, via the at least one transceiver, from the UE, a capability message indicating a capability of the UE to obtain the frequency offset measurement based on the one or more narrowband PRS resources.

Clause 100. The network entity of any of clauses 81 to 99, wherein the frequency offset measurement is received: as a normalized value without units, in units of parts-per-million (ppm), in units of velocity, in units of frequency, or as a difference between an actual frequency offset measurement obtained by the UE and an expected frequency offset measurement transmitted to the UE in the assistance data.

Clause 101. The network entity of any of clauses 81 to 100, wherein: the assistance data includes a range and resolution for reporting the frequency offset measurement per TRP, component carrier, frequency band, or frequency layer, or the assistance data includes a range and resolution for reporting the frequency offset measurement per TRP in ppm units.

Clause 102. The network entity of any of clauses 81 to 101, wherein the at least one processor configured to transmit the assistance data comprises the at least one processor configured to: transmit, via the at least one transceiver, the assistance data in one or more Long-Term Evolution (LTE) positioning protocol (LPP) messages; or broadcast the assistance data in one or more positioning system information blocks (posSIBs).

Clause 103. The network entity of any of clauses 81 to 102, wherein the at least one TRP comprises at least one space vehicle.

Clause 104. The network entity of any of clauses 81 to 103, wherein the network entity is a location server.

Clause 105. A user equipment (UE), comprising: means for receiving assistance data for a positioning procedure; means for obtaining a frequency offset measurement of one or more positioning reference signal (PRS) resources transmitted by at least one transmission-reception point (TRP) based on the assistance data; and means for enabling a location of the UE to be determined based, at least in part, on the frequency offset measurement.

Clause 106. The UE of clause 105, wherein the frequency offset measurement is based on a first phase measurement of a first symbol of the one or more PRS resources, a second phase measurement of a second symbol of the one or more PRS resources, and a difference in time between the first symbol and the second symbol.

Clause 107. The UE of clause 106, wherein the first symbol and the second symbol have the same allocation of PRS resource elements of the one or more PRS resources.

Clause 108. The UE of any of clauses 106 to 107, wherein: the first symbol and the second symbol are within the same slot, and the difference in time indicates a number of symbols between the first symbol and the second symbol.

Clause 109. The UE of clause 108, wherein: the one or more PRS resources are a single PRS resource, the single PRS resource comprises at least two repetitions of a comb pattern of the single PRS resource, and the at least two repetitions of the comb pattern are separated by the difference in time.

Clause 110. The UE of any of clauses 106 to 107, wherein: the first symbol and the second symbol are in different slots, and the difference in time indicates a number of slots between the different slots.

Clause 111. The UE of clause 110, wherein the one or more PRS resources in the different slots have the same comb pattern.

Clause 112. The UE of any of clauses 106 to 111, wherein: the first symbol and the second symbol belong to the same PRS resource of the one or more PRS resources.

Clause 113. The UE of any of clauses 106 to 111, wherein: the first symbol belongs to a first PRS resource of the one or more PRS resources, and the second symbol belongs to a second PRS resource of the one or more PRS resources different than the first PRS resource.

Clause 114. The UE of clause 113, wherein the assistance data indicates that the first PRS resource and the second PRS resource are configured to be transmitted by the at least one TRP with phase coherence.

Clause 115. The UE of any of clauses 106 to 114, further comprising: means for transmitting, to a location server, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 116. The UE of any of clauses 106 to 115, wherein: the first phase measurement is a first phase of a first linear average of a first channel response of a first path delay of PRS resource elements of the first symbol of the one or more PRS resources, and the second phase measurement is a second phase of a second linear average of a second channel response of a second path delay of PRS resource elements of the second symbol of the one or more PRS resources.

Clause 117. The UE of any of clauses 106 to 116, wherein the assistance data includes an index of the first symbol, an index of the second symbol, and the difference in time.

Clause 118. The UE of any of clauses 105 to 117, further comprising: means for transmitting, to a location server, a capability message indicating a capability of the UE to engage in a frequency difference of arrival (FDOA) positioning procedure, to report the frequency offset measurement, or both.

Clause 119. The UE of any of clauses 105 to 118, wherein the positioning procedure is an FDOA positioning procedure.

Clause 120. The UE of any of clauses 105 to 119, wherein the means for enabling the location of the UE to be determined comprises: means for reporting the frequency offset measurement to a location server to enable the location server to determine the location of the UE.

Clause 121. The UE of clause 120, wherein: the positioning procedure is a time-difference of arrival (TDOA) positioning procedure, and the frequency offset measurement is reported to the location server as part of the TDOA positioning procedure.

Clause 122. The UE of any of clauses 120 to 121, wherein the means for reporting the frequency offset measurement comprises: means for reporting a first frequency offset measurement of a first dominant path of the one or more PRS resources; and means for reporting one or more second frequency offset measurements of one or more additional paths of the one or more PRS resources.

Clause 123. The UE of clause 122, further comprising: means for transmitting, to the location server, a capability message indicating a capability of the UE to report the one or more second frequency offset measurements.

Clause 124. The UE of any of clauses 105 to 119, wherein the means for enabling the location of the UE to be determined comprises: means for determining the location of the UE based on the frequency offset measurement and ephemeris information for the at least one TRP.

Clause 125. The UE of any of clauses 105 to 124, wherein the one or more PRS resources are one or more narrowband PRS resources.

Clause 126. The UE of clause 125, further comprising: means for transmitting, to a location server, a capability message indicating a capability of the UE to obtain the frequency offset measurement based on the one or more narrowband PRS resources.

Clause 127. The UE of any of clauses 105 to 126, wherein the frequency offset measurement is reported: as a normalized value without units, in units of parts-per-million (ppm), in units of velocity, in units of frequency, or as a difference between an actual frequency offset measurement obtained by the UE and an expected frequency offset measurement received in the assistance data.

Clause 128. The UE of any of clauses 105 to 127, wherein the assistance data includes a range and resolution for reporting the frequency offset measurement per TRP, component carrier, frequency band, or frequency layer.

Clause 129. The UE of any of clauses 105 to 128, wherein: the assistance data includes a range and resolution for reporting the frequency offset measurement per TRP in ppm units, and the UE translates the range and resolution to a range and resolution per component carrier, frequency band, or frequency layer.

Clause 130. The UE of any of clauses 105 to 129, further comprising: means for determining a range and resolution of the frequency offset measurement based on an orbit of the at least one TRP.

Clause 131. The UE of any of clauses 105 to 130, wherein the assistance data is received from: a location server in one or more Long-Term Evolution (LTE) positioning protocol (LPP) messages, or a base station in one or more positioning system information blocks (posSIBs) broadcasted by the base station.

Clause 132. The UE of any of clauses 105 to 131, wherein the at least one TRP comprises at least one space vehicle.

Clause 133. A network entity, comprising: means for transmitting, to a user equipment (UE), assistance data for a positioning procedure; means for receiving, from the UE, a frequency offset measurement of one or more positioning reference signal (PRS) resources transmitted by at least one transmission-reception point (TRP); and means for determining a location of the UE based, at least in part, on the frequency offset measurement.

Clause 134. The network entity of clause 133, wherein the frequency offset measurement is based on a first phase measurement of a first symbol of the one or more PRS resources, a second phase measurement of a second symbol of the one or more PRS resources, and a difference in time between the first symbol and the second symbol.

Clause 135. The network entity of clause 134, wherein the first symbol and the second symbol have the same allocation of PRS resource elements of the one or more PRS resources.

Clause 136. The network entity of any of clauses 134 to 135, wherein: the first symbol and the second symbol are within the same slot, and the difference in time indicates a number of symbols between the first symbol and the second symbol.

Clause 137. The network entity of clause 136, wherein: the one or more PRS resources are a single PRS resource, the single PRS resource comprises at least two repetitions of a comb pattern of the single PRS resource, and the at least two repetitions of the comb pattern are separated by the difference in time.

Clause 138. The network entity of any of clauses 134 to 135, wherein: the first symbol and the second symbol are in different slots, and the difference in time indicates a number of slots between the different slots.

Clause 139. The network entity of clause 138, wherein the one or more PRS resources in the different slots have the same comb pattern.

Clause 140. The network entity of any of clauses 134 to 139, wherein: the first symbol and the second symbol belong to the same PRS resource of the one or more PRS resources.

Clause 141. The network entity of any of clauses 134 to 139, wherein: the first symbol belongs to a first PRS resource of the one or more PRS resources, and the second symbol belongs to a second PRS resource of the one or more PRS resources different than the first PRS resource.

Clause 142. The network entity of clause 141, wherein the assistance data indicates that the first PRS resource and the second PRS resource are configured to be transmitted by the at least one TRP with phase coherence.

Clause 143. The network entity of any of clauses 134 to 142, further comprising: means for receiving, from the UE, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 144. The network entity of any of clauses 134 to 143, wherein the assistance data includes an index of the first symbol, an index of the second symbol, and the difference in time.

Clause 145. The network entity of any of clauses 133 to 144, further comprising: means for receiving, from the UE, a capability message indicating a capability of the UE to engage in a frequency difference of arrival (FDOA) positioning procedure, to report the frequency offset measurement, or both.

Clause 146. The network entity of any of clauses 133 to 145, wherein the positioning procedure is an FDOA positioning procedure.

Clause 147. The network entity of any of clauses 133 to 146, wherein: the positioning procedure is a time-difference of arrival (TDOA) positioning procedure, and the frequency offset measurement is received from the UE as part of the TDOA positioning procedure.

Clause 148. The network entity of any of clauses 133 to 147, wherein the means for receiving the frequency offset measurement comprises: means for receiving a first frequency offset measurement of a first dominant path of the one or more PRS resources;

and means for receiving one or more second frequency offset measurements of one or more additional paths of the one or more PRS resources.

Clause 149. The network entity of clause 148, further comprising: means for receiving, from the UE, a capability message indicating a capability of the UE to report the one or more second frequency offset measurements.

Clause 150. The network entity of any of clauses 133 to 149, wherein the one or more PRS resources are one or more narrowband PRS resources.

Clause 151. The network entity of clause 150, further comprising: means for receiving, from the UE, a capability message indicating a capability of the UE to obtain the frequency offset measurement based on the one or more narrowband PRS resources.

Clause 152. The network entity of any of clauses 133 to 151, wherein the frequency offset measurement is received: as a normalized value without units, in units of parts-per-million (ppm), in units of velocity, in units of frequency, or as a difference between an actual frequency offset measurement obtained by the UE and an expected frequency offset measurement transmitted to the UE in the assistance data.

Clause 153. The network entity of any of clauses 133 to 152, wherein: the assistance data includes a range and resolution for reporting the frequency offset measurement per TRP, component carrier, frequency band, or frequency layer, or the assistance data includes a range and resolution for reporting the frequency offset measurement per TRP in ppm units.

Clause 154. The network entity of any of clauses 133 to 153, wherein the means for transmitting the assistance data comprises: means for transmitting the assistance data in one or more Long-Term Evolution (LTE) positioning protocol (LPP) messages; or means for broadcasting the assistance data in one or more positioning system information blocks (posSIBs).

Clause 155. The network entity of any of clauses 133 to 154, wherein the at least one TRP comprises at least one space vehicle.

Clause 156. The network entity of any of clauses 133 to 155, wherein the network entity is a location server.

Clause 157. A non-transitory computer-readable medium storing computer-executable instructions that, when executed by a user equipment (UE), cause the UE to: receive assistance data for a positioning procedure; obtain a frequency offset measurement of one or more positioning reference signal (PRS) resources transmitted by at least one transmission-reception point (TRP) based on the assistance data; and enable a location of the UE to be determined based, at least in part, on the frequency offset measurement.

Clause 158. The non-transitory computer-readable medium of clause 157, wherein the frequency offset measurement is based on a first phase measurement of a first symbol of the one or more PRS resources, a second phase measurement of a second symbol of the one or more PRS resources, and a difference in time between the first symbol and the second symbol.

Clause 159. The non-transitory computer-readable medium of clause 158, wherein the first symbol and the second symbol have the same allocation of PRS resource elements of the one or more PRS resources.

Clause 160. The non-transitory computer-readable medium of any of clauses 158 to 159, wherein: the first symbol and the second symbol are within the same slot, and the difference in time indicates a number of symbols between the first symbol and the second symbol.

Clause 161. The non-transitory computer-readable medium of clause 160, wherein: the one or more PRS resources are a single PRS resource, the single PRS resource comprises at least two repetitions of a comb pattern of the single PRS resource, and the at least two repetitions of the comb pattern are separated by the difference in time.

Clause 162. The non-transitory computer-readable medium of any of clauses 158 to 159, wherein: the first symbol and the second symbol are in different slots, and the difference in time indicates a number of slots between the different slots.

Clause 163. The non-transitory computer-readable medium of clause 162, wherein the one or more PRS resources in the different slots have the same comb pattern.

Clause 164. The non-transitory computer-readable medium of any of clauses 158 to 163, wherein: the first symbol and the second symbol belong to the same PRS resource of the one or more PRS resources.

Clause 165. The non-transitory computer-readable medium of any of clauses 158 to 163, wherein: the first symbol belongs to a first PRS resource of the one or more PRS resources, and the second symbol belongs to a second PRS resource of the one or more PRS resources different than the first PRS resource.

Clause 166. The non-transitory computer-readable medium of clause 165, wherein the assistance data indicates that the first PRS resource and the second PRS resource are configured to be transmitted by the at least one TRP with phase coherence.

Clause 167. The non-transitory computer-readable medium of any of clauses 158 to 166, further comprising computer-executable instructions that, when executed by the UE, cause the UE to: transmit, to a location server, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 168. The non-transitory computer-readable medium of any of clauses 158 to 167, wherein: the first phase measurement is a first phase of a first linear average of a first channel response of a first path delay of PRS resource elements of the first symbol of the one or more PRS resources, and the second phase measurement is a second phase of a second linear average of a second channel response of a second path delay of PRS resource elements of the second symbol of the one or more PRS resources.

Clause 169. The non-transitory computer-readable medium of any of clauses 158 to 168, wherein the assistance data includes an index of the first symbol, an index of the second symbol, and the difference in time.

Clause 170. The non-transitory computer-readable medium of any of clauses 157 to 169, further comprising computer-executable instructions that, when executed by the UE, cause the UE to: transmit, to a location server, a capability message indicating a capability of the UE to engage in a frequency difference of arrival (FDOA) positioning procedure, to report the frequency offset measurement, or both.

Clause 171. The non-transitory computer-readable medium of any of clauses 157 to 170, wherein the positioning procedure is an FDOA positioning procedure.

Clause 172. The non-transitory computer-readable medium of any of clauses 157 to 171, wherein the computer-executable instructions that, when executed by the UE, cause the UE to enable the location of the UE to be determined comprise computer-executable instructions that, when executed by the UE, cause the UE to: report the frequency offset measurement to a location server to enable the location server to determine the location of the UE.

Clause 173. The non-transitory computer-readable medium of clause 172, wherein: the positioning procedure is a time-difference of arrival (TDOA) positioning procedure, and the frequency offset measurement is reported to the location server as part of the TDOA positioning procedure.

Clause 174. The non-transitory computer-readable medium of any of clauses 172 to 173, wherein the computer-executable instructions that, when executed by the UE, cause the UE to report the frequency offset measurement comprise computer-executable instructions that, when executed by the UE, cause the UE to: report a first frequency offset measurement of a first dominant path of the one or more PRS resources; and report one or more second frequency offset measurements of one or more additional paths of the one or more PRS resources.

Clause 175. The non-transitory computer-readable medium of clause 174, further comprising computer-executable instructions that, when executed by the UE, cause the UE to: transmit, to the location server, a capability message indicating a capability of the UE to report the one or more second frequency offset measurements.

Clause 176. The non-transitory computer-readable medium of any of clauses 157 to 171, wherein the computer-executable instructions that, when executed by the UE, cause the UE to enable the location of the UE to be determined comprise computer-executable instructions that, when executed by the UE, cause the UE to: determine the location of the UE based on the frequency offset measurement and ephemeris information for the at least one TRP.

Clause 177. The non-transitory computer-readable medium of any of clauses 157 to 176, wherein the one or more PRS resources are one or more narrowband PRS resources.

Clause 178. The non-transitory computer-readable medium of clause 177, further comprising computer-executable instructions that, when executed by the UE, cause the UE to: transmit, to a location server, a capability message indicating a capability of the UE to obtain the frequency offset measurement based on the one or more narrowband PRS resources.

Clause 179. The non-transitory computer-readable medium of any of clauses 157 to 178, wherein the frequency offset measurement is reported: as a normalized value without units, in units of parts-per-million (ppm), in units of velocity, in units of frequency, or as a difference between an actual frequency offset measurement obtained by the UE and an expected frequency offset measurement received in the assistance data.

Clause 180. The non-transitory computer-readable medium of any of clauses 157 to 179, wherein the assistance data includes a range and resolution for reporting the frequency offset measurement per TRP, component carrier, frequency band, or frequency layer.

Clause 181. The non-transitory computer-readable medium of any of clauses 157 to 180, wherein: the assistance data includes a range and resolution for reporting the frequency offset measurement per TRP in ppm units, and the UE translates the range and resolution to a range and resolution per component carrier, frequency band, or frequency layer.

Clause 182. The non-transitory computer-readable medium of any of clauses 157 to 181, further comprising computer-executable instructions that, when executed by the UE, cause the UE to: determine a range and resolution of the frequency offset measurement based on an orbit of the at least one TRP.

Clause 183. The non-transitory computer-readable medium of any of clauses 157 to 182, wherein the assistance data is received from: a location server in one or more Long-Term Evolution (LTE) positioning protocol (LPP) messages, or a base station in one or more positioning system information blocks (posSIBs) broadcasted by the base station.

Clause 184. The non-transitory computer-readable medium of any of clauses 157 to 183, wherein the at least one TRP comprises at least one space vehicle.

Clause 185. A non-transitory computer-readable medium storing computer-executable instructions that, when executed by a network entity, cause the network entity to: transmit, to a user equipment (UE), assistance data for a positioning procedure; receive, from the UE, a frequency offset measurement of one or more positioning reference signal (PRS) resources transmitted by at least one transmission-reception point (TRP); and determine a location of the UE based, at least in part, on the frequency offset measurement.

Clause 186. The non-transitory computer-readable medium of clause 185, wherein the frequency offset measurement is based on a first phase measurement of a first symbol of the one or more PRS resources, a second phase measurement of a second symbol of the one or more PRS resources, and a difference in time between the first symbol and the second symbol.

Clause 187. The non-transitory computer-readable medium of clause 186, wherein the first symbol and the second symbol have the same allocation of PRS resource elements of the one or more PRS resources.

Clause 188. The non-transitory computer-readable medium of any of clauses 186 to 187, wherein: the first symbol and the second symbol are within the same slot, and the difference in time indicates a number of symbols between the first symbol and the second symbol.

Clause 189. The non-transitory computer-readable medium of clause 188, wherein: the one or more PRS resources are a single PRS resource, the single PRS resource comprises at least two repetitions of a comb pattern of the single PRS resource, and the at least two repetitions of the comb pattern are separated by the difference in time.

Clause 190. The non-transitory computer-readable medium of any of clauses 186 to 187, wherein: the first symbol and the second symbol are in different slots, and the difference in time indicates a number of slots between the different slots.

Clause 191. The non-transitory computer-readable medium of clause 190, wherein the one or more PRS resources in the different slots have the same comb pattern.

Clause 192. The non-transitory computer-readable medium of any of clauses 186 to 191, wherein: the first symbol and the second symbol belong to the same PRS resource of the one or more PRS resources.

Clause 193. The non-transitory computer-readable medium of any of clauses 186 to 191, wherein: the first symbol belongs to a first PRS resource of the one or more PRS resources, and the second symbol belongs to a second PRS resource of the one or more PRS resources different than the first PRS resource.

Clause 194. The non-transitory computer-readable medium of clause 193, wherein the assistance data indicates that the first PRS resource and the second PRS resource are configured to be transmitted by the at least one TRP with phase coherence.

Clause 195. The non-transitory computer-readable medium of any of clauses 186 to 194, further comprising computer-executable instructions that, when executed by the network entity, cause the network entity to: receive, from the UE, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

Clause 196. The non-transitory computer-readable medium of any of clauses 186 to 195, wherein the assistance data includes an index of the first symbol, an index of the second symbol, and the difference in time.

Clause 197. The non-transitory computer-readable medium of any of clauses 185 to 196, further comprising computer-executable instructions that, when executed by the network entity, cause the network entity to: receive, from the UE, a capability message indicating a capability of the UE to engage in a frequency difference of arrival (FDOA) positioning procedure, to report the frequency offset measurement, or both.

Clause 198. The non-transitory computer-readable medium of any of clauses 185 to 197, wherein the positioning procedure is an FDOA positioning procedure.

Clause 199. The non-transitory computer-readable medium of any of clauses 185 to 198, wherein: the positioning procedure is a time-difference of arrival (TDOA) positioning procedure, and the frequency offset measurement is received from the UE as part of the TDOA positioning procedure.

Clause 200. The non-transitory computer-readable medium of any of clauses 185 to 199, wherein the computer-executable instructions that, when executed by the network entity, cause the network entity to receive the frequency offset measurement comprise computer-executable instructions that, when executed by the network entity, cause the network entity to: receive a first frequency offset measurement of a first dominant path of the one or more PRS resources; and receive one or more second frequency offset measurements of one or more additional paths of the one or more PRS resources.

Clause 201. The non-transitory computer-readable medium of clause 200, further comprising computer-executable instructions that, when executed by the network entity, cause the network entity to: receive, from the UE, a capability message indicating a capability of the UE to report the one or more second frequency offset measurements.

Clause 202. The non-transitory computer-readable medium of any of clauses 185 to 201, wherein the one or more PRS resources are one or more narrowband PRS resources.

Clause 203. The non-transitory computer-readable medium of clause 202, further comprising computer-executable instructions that, when executed by the network entity, cause the network entity to: receive, from the UE, a capability message indicating a capability of the UE to obtain the frequency offset measurement based on the one or more narrowband PRS resources.

Clause 204. The non-transitory computer-readable medium of any of clauses 185 to 203, wherein the frequency offset measurement is received: as a normalized value without units, in units of parts-per-million (ppm), in units of velocity, in units of frequency, or as a difference between an actual frequency offset measurement obtained by the UE and an expected frequency offset measurement transmitted to the UE in the assistance data.

Clause 205. The non-transitory computer-readable medium of any of clauses 185 to 204, wherein: the assistance data includes a range and resolution for reporting the frequency offset measurement per TRP, component carrier, frequency band, or frequency layer, or the assistance data includes a range and resolution for reporting the frequency offset measurement per TRP in ppm units.

Clause 206. The non-transitory computer-readable medium of any of clauses 185 to 205, wherein the computer-executable instructions that, when executed by the network entity, cause the network entity to transmit the assistance data comprise computer-executable instructions that, when executed by the network entity, cause the network entity to: transmit the assistance data in one or more Long-Term Evolution (LTE) positioning protocol (LPP) messages; or broadcast the assistance data in one or more positioning system information blocks (posSIBs).

Clause 207. The non-transitory computer-readable medium of any of clauses 185 to 206, wherein the at least one TRP comprises at least one space vehicle.

Clause 208. The non-transitory computer-readable medium of any of clauses 185 to 207, wherein the network entity is a location server.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless positioning performed by a user equipment (UE), comprising:
receiving assistance data for a positioning procedure;
obtaining a frequency offset measurement of one or more positioning reference signal (PRS) resources transmitted by at least one transmission-reception point (TRP) based on the assistance data; and
enabling a location of the UE to be determined based, at least in part, on the frequency offset measurement.

2. The method of claim 1, wherein the frequency offset measurement is based on a first phase measurement of a first symbol of the one or more PRS resources, a second phase measurement of a second symbol of the one or more PRS resources, and a difference in time between the first symbol and the second symbol.

3. The method of claim 2, wherein the first symbol and the second symbol have the same allocation of PRS resource elements of the one or more PRS resources.

4. The method of claim 2, wherein:
the first symbol and the second symbol are within the same slot, and
the difference in time indicates a number of symbols between the first symbol and the second symbol.

5. The method of claim 4, wherein:
the one or more PRS resources are a single PRS resource,
the single PRS resource comprises at least two repetitions of a comb pattern of the single PRS resource, and
the at least two repetitions of the comb pattern are separated by the difference in time.

6. The method of claim 2, wherein:
the first symbol and the second symbol are in different slots, and
the difference in time indicates a number of slots between the different slots.

7. The method of claim 6, wherein the one or more PRS resources in the different slots have the same comb pattern.

8. The method of claim 2, wherein:
the first symbol and the second symbol belong to the same PRS resource of the one or more PRS resources.

9. The method of claim 2, wherein:
the first symbol belongs to a first PRS resource of the one or more PRS resources, and
the second symbol belongs to a second PRS resource of the one or more PRS resources different than the first PRS resource.

10. The method of claim 9, wherein the assistance data indicates that the first PRS resource and the second PRS resource are configured to be transmitted by the at least one TRP with phase coherence.

11. The method of claim 2, further comprising:
transmitting, to a location server, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

12. The method of claim 2, wherein:
the first phase measurement is a first phase of a first linear average of a first channel response of a first path delay of PRS resource elements of the first symbol of the one or more PRS resources, and
the second phase measurement is a second phase of a second linear average of a second channel response of a second path delay of PRS resource elements of the second symbol of the one or more PRS resources.

13. The method of claim 2, wherein the assistance data includes an index of the first symbol, an index of the second symbol, and the difference in time.

14. The method of claim 1, further comprising:
transmitting, to a location server, a capability message indicating a capability of the UE to engage in a frequency difference of arrival (FDOA) positioning procedure, to report the frequency offset measurement, or both.

15. The method of claim 1, wherein the positioning procedure is an FDOA positioning procedure.

16. The method of claim 1, wherein enabling the location of the UE to be determined comprises:
reporting the frequency offset measurement to a location server to enable the location server to determine the location of the UE.

17. The method of claim 16, wherein:
the positioning procedure is a time-difference of arrival (TDOA) positioning procedure, and
the frequency offset measurement is reported to the location server as part of the TDOA positioning procedure.

18. The method of claim 16, wherein reporting the frequency offset measurement comprises:
reporting a first frequency offset measurement of a first dominant path of the one or more PRS resources; and
reporting one or more second frequency offset measurements of one or more additional paths of the one or more PRS resources.

19. The method of claim 18, further comprising:
transmitting, to the location server, a capability message indicating a capability of the UE to report the one or more second frequency offset measurements.

20. The method of claim 1, wherein enabling the location of the UE to be determined comprises:
determining the location of the UE based on the frequency offset measurement and ephemeris information for the at least one TRP.

21. The method of claim 1, wherein the one or more PRS resources are one or more narrowband PRS resources.

22. The method of claim 21, further comprising:
transmitting, to a location server, a capability message indicating a capability of the UE to obtain the frequency offset measurement based on the one or more narrowband PRS resources.

23. The method of claim 1, wherein the frequency offset measurement is reported:
as a normalized value without units,
in units of parts-per-million (ppm),
in units of velocity,
in units of frequency, or
as a difference between an actual frequency offset measurement obtained by the UE and an expected frequency offset measurement received in the assistance data.

24. The method of claim 1, wherein the assistance data includes a range and resolution for reporting the frequency offset measurement per TRP, component carrier, frequency band, or frequency layer.

25. The method of claim 1, wherein:
the assistance data includes a range and resolution for reporting the frequency offset measurement per TRP in ppm units, and
the UE translates the range and resolution to a range and resolution per component carrier, frequency band, or frequency layer.

26. The method of claim 1, further comprising:
determining a range and resolution of the frequency offset measurement based on an orbit of the at least one TRP.

27. The method of claim 1, wherein the assistance data is received from:
a location server in one or more Long-Term Evolution (LTE) positioning protocol (LPP) messages, or
a base station in one or more positioning system information blocks (posSIBs) broadcasted by the base station.

28. The method of claim 1, wherein the at least one TRP comprises at least one space vehicle.

29. A method of positioning performed by a network entity, comprising:
transmitting, to a user equipment (UE), assistance data for a positioning procedure;
receiving, from the UE, a frequency offset measurement of one or more positioning reference signal (PRS) resources transmitted by at least one transmission-reception point (TRP); and
determining a location of the UE based, at least in part, on the frequency offset measurement.

30. The method of claim 29, wherein the frequency offset measurement is based on a first phase measurement of a first symbol of the one or more PRS resources, a second phase measurement of a second symbol of the one or more PRS resources, and a difference in time between the first symbol and the second symbol.

31. The method of claim 30, wherein the first symbol and the second symbol have the same allocation of PRS resource elements of the one or more PRS resources.

32. The method of claim 30, wherein:
the first symbol and the second symbol are within the same slot, and
the difference in time indicates a number of symbols between the first symbol and the second symbol.

33. The method of claim 32, wherein:
the one or more PRS resources are a single PRS resource,
the single PRS resource comprises at least two repetitions of a comb pattern of the single PRS resource, and
the at least two repetitions of the comb pattern are separated by the difference in time.

34. The method of claim 30, wherein:
the first symbol and the second symbol are in different slots, and
the difference in time indicates a number of slots between the different slots.

35. The method of claim 34, wherein the one or more PRS resources in the different slots have the same comb pattern.

36. The method of claim 30, wherein:
the first symbol and the second symbol belong to the same PRS resource of the one or more PRS resources.

37. The method of claim 30, wherein:
the first symbol belongs to a first PRS resource of the one or more PRS resources, and
the second symbol belongs to a second PRS resource of the one or more PRS resources different than the first PRS resource.

38. The method of claim 37, wherein the assistance data indicates that the first PRS resource and the second PRS resource are configured to be transmitted by the at least one TRP with phase coherence.

39. The method of claim 30, further comprising:
receiving, from the UE, a capability message indicating a capability of the UE to obtain the first phase measurement and the second phase measurement from the same PRS resource of the one or more PRS resources or to obtain the first phase measurement and the second phase measurement from different PRS resources of the one or more PRS resources.

40. The method of claim 30, wherein the assistance data includes an index of the first symbol, an index of the second symbol, and the difference in time.

41. The method of claim 29, further comprising:
receiving, from the UE, a capability message indicating a capability of the UE to engage in a frequency difference of arrival (FDOA) positioning procedure, to report the frequency offset measurement, or both.

42. The method of claim 29, wherein the positioning procedure is an FDOA positioning procedure.

43. The method of claim 29, wherein:
the positioning procedure is a time-difference of arrival (TDOA) positioning procedure, and
the frequency offset measurement is received from the UE as part of the TDOA positioning procedure.

44. The method of claim 29, wherein receiving the frequency offset measurement comprises:
receiving a first frequency offset measurement of a first dominant path of the one or more PRS resources; and
receiving one or more second frequency offset measurements of one or more additional paths of the one or more PRS resources.

45. The method of claim 44, further comprising:
receiving, from the UE, a capability message indicating a capability of the UE to report the one or more second frequency offset measurements.

46. The method of claim 29, wherein the one or more PRS resources are one or more narrowband PRS resources.

47. The method of claim 46, further comprising:
receiving, from the UE, a capability message indicating a capability of the UE to obtain the frequency offset measurement based on the one or more narrowband PRS resources.

48. The method of claim 29, wherein the frequency offset measurement is received:
as a normalized value without units,
in units of parts-per-million (ppm),
in units of velocity,
in units of frequency, or
as a difference between an actual frequency offset measurement obtained by the UE and an expected frequency offset measurement transmitted to the UE in the assistance data.

49. The method of claim 29, wherein:
the assistance data includes a range and resolution for reporting the frequency offset measurement per TRP, component carrier, frequency band, or frequency layer, or
the assistance data includes a range and resolution for reporting the frequency offset measurement per TRP in ppm units.

50. The method of claim 29, wherein transmitting the assistance data comprises:
transmitting the assistance data in one or more Long-Term Evolution (LTE) positioning protocol (LPP) messages; or
broadcasting the assistance data in one or more positioning system information blocks (posSIBs).

51. The method of claim 29, wherein the at least one TRP comprises at least one space vehicle.

52. The method of claim 29, wherein the network entity is a location server.

53. A user equipment (UE), comprising:
a memory;
at least one transceiver; and
at least one processor communicatively coupled to the memory and the at least one transceiver, the at least one processor configured to:
receive, via the at least one transceiver, assistance data for a positioning procedure;
obtain a frequency offset measurement of one or more positioning reference signal (PRS) resources transmitted by at least one transmission-reception point (TRP) based on the assistance data; and
enable a location of the UE to be determined based, at least in part, on the frequency offset measurement.

54. The UE of claim 53, wherein the frequency offset measurement is based on a first phase measurement of a first symbol of the one or more PRS resources, a second phase measurement of a second symbol of the one or more PRS resources, and a difference in time between the first symbol and the second symbol.

55. The UE of claim 53, wherein the at least one processor is further configured to:
transmit, via the at least one transceiver, to a location server, a capability message indicating a capability of the UE to engage in a frequency difference of arrival (FDOA) positioning procedure, to report the frequency offset measurement, or both.

56. The UE of claim 53, wherein the at least one processor configured to enable the location of the UE to be determined comprises the at least one processor configured to:
report, via the at least one transceiver, the frequency offset measurement to a location server to enable the location server to determine the location of the UE.

57. The UE of claim 56, wherein:
the positioning procedure is a time-difference of arrival (TDOA) positioning procedure, and
the frequency offset measurement is reported to the location server as part of the TDOA positioning procedure.

58. The UE of claim 53, wherein the frequency offset measurement is reported:
as a normalized value without units,
in units of parts-per-million (ppm),
in units of velocity,
in units of frequency, or
as a difference between an actual frequency offset measurement obtained by the UE and an expected frequency offset measurement received in the assistance data.

59. A network entity, comprising:
a memory;
at least one transceiver; and
at least one processor communicatively coupled to the memory and the at least one transceiver, the at least one processor configured to:
transmit, via the at least one transceiver, to a user equipment (UE), assistance data for a positioning procedure;
receive, via the at least one transceiver, from the UE, a frequency offset measurement of one or more positioning reference signal (PRS) resources transmitted by at least one transmission-reception point (TRP); and
determine a location of the UE based, at least in part, on the frequency offset measurement.

60. The network entity of claim 59, wherein the frequency offset measurement is based on a first phase measurement of a first symbol of the one or more PRS resources, a second phase measurement of a second symbol of the one or more PRS resources, and a difference in time between the first symbol and the second symbol.

61. The network entity of claim 59, wherein the at least one processor is further configured to:
receive, via the at least one transceiver, from the UE, a capability message indicating a capability of the UE to engage in a frequency difference of arrival (FDOA) positioning procedure, to report the frequency offset measurement, or both.

62. The network entity of claim 59, wherein:
the positioning procedure is a time-difference of arrival (TDOA) positioning procedure, and
the frequency offset measurement is received from the UE as part of the TDOA positioning procedure.

63. The network entity of claim 59, wherein the frequency offset measurement is received:
as a normalized value without units,
in units of parts-per-million (ppm),
in units of velocity,
in units of frequency, or
as a difference between an actual frequency offset measurement obtained by the UE and an expected frequency offset measurement transmitted to the UE in the assistance data.

64. The network entity of claim 59, wherein the at least one processor configured to transmit the assistance data comprises the at least one processor configured to:
transmit, via the at least one transceiver, the assistance data in one or more Long-Term Evolution (LTE) positioning protocol (LPP) messages; or
broadcast, via the at least one transceiver, the assistance data in one or more positioning system information blocks (posSIBs).

65. A user equipment (UE), comprising:
means for receiving assistance data for a positioning procedure;
means for obtaining a frequency offset measurement of one or more positioning reference signal (PRS) resources transmitted by at least one transmission-reception point (TRP) based on the assistance data; and
means for enabling a location of the UE to be determined based, at least in part, on the frequency offset measurement.

66. A network entity, comprising:
means for transmitting, to a user equipment (UE), assistance data for a positioning procedure;
means for receiving, from the UE, a frequency offset measurement of one or more positioning reference signal (PRS) resources transmitted by at least one transmission-reception point (TRP); and
means for determining a location of the UE based, at least in part, on the frequency offset measurement.

67. A non-transitory computer-readable medium storing computer-executable instructions that, when executed by a user equipment (UE), cause the UE to:
receive assistance data for a positioning procedure;
obtain a frequency offset measurement of one or more positioning reference signal (PRS) resources transmitted by at least one transmission-reception point (TRP) based on the assistance data; and
enable a location of the UE to be determined based, at least in part, on the frequency offset measurement.

68. A non-transitory computer-readable medium storing computer-executable instructions that, when executed by a network entity, cause the network entity to:
transmit, to a user equipment (UE), assistance data for a positioning procedure;
receive, from the UE, a frequency offset measurement of one or more positioning reference signal (PRS) resources transmitted by at least one transmission-reception point (TRP); and
determine a location of the UE based, at least in part, on the frequency offset measurement.
